(19) United States
(12) Patent Application Publication
(10) Pub. No.: US 2026/0084942 A1
(43) Pub. Date: Mar. 26, 2026

(54) HANDLING SYSTEM FOR HANDLING SECTIONS OF A STRUCTURE

(71) Applicant: Gregory John NEIGHBOURS, Morningside, Auckland (NZ)

(72) Inventor: Gregory John NEIGHBOURS, Morningside, Auckland (NZ)

(21) Appl. No.: 19/109,496

(22) PCT Filed: Sep. 8, 2023
(86) PCT No.: PCT/IB2023/058894

§ 371 Date: Mar. 6, 2025

(30) Foreign Application Priority Data
Sep. 8, 2022 (AU) 2022902589

(51) Int. Cl. B66F 3/08; B66F 3/46; E04G 21/16; F03D 13/10

(52) U.S. Cl. CPC B66F 3/08; B66F 3/46; E04G 21/163; F03D 13/112; F03D 13/139; F05B 2240/912

(57) ABSTRACT

A handling system for assembling an elongate structure such as a wind tower from a plurality of sections thereof along a vertical axis, and methods for erecting said structure and aligning sections thereof. The handling system comprises a plurality of spaced apart interfacing elements for engaging a section to be handled and a jacking arrangement for moving the interfacing elements radially and vertically.

### BACKGROUND

### Technical Field

The present disclosure relates to a handling system for assembling an elongate structure from a plurality of sections, and to methods for erection of said structure. More particularly, but not exclusively, the disclosure relates to a handling system and method for assembling an elongate tower of a wind turbine installation from a plurality of concrete rings.

### Description of the Related Art

Handling cumbersome, heavy and/or unwieldy sections of large structures (e.g., civil engineering structures or installations), either for moving those sections or for erection of the structures, is generally carried out using conventional crane systems and construction methods. There may be safety risks, delays, and downtime associated with the employment of these large, cumbersome and inefficient systems and methods.

Some structures, such as sections of an elongate tower of a wind turbine installation, can prove particularly challenging. Current systems may employ either crane systems arranged around the foundation of the tower to be built, or a self-climbing crane system which climbs the tower as it gains in height. These systems are vulnerable to high dynamic wind loads, as the tower grows in height, as well structural limitations borne from the stiffness required from such cranes at significant heights and when lifting significant tonnages. The slow speed of construction associated with carefully accounting for such limitations can also add significant labour and costs.

It is an object of the present disclosure to provide a handling system and method for assembling an elongate structure from a plurality of sections, which overcomes or at least partially ameliorates some of the abovementioned disadvantages or at least provides the public with a useful choice.

### BRIEF SUMMARY

In a first aspect, the disclosure broadly provides a handling system for assembling an elongate structure from a plurality of sections along a vertical axis. The handling system comprises a plurality of spaced apart interfacing elements for engaging a section of the structure to be handled, and a jacking arrangement. The jacking arrangement comprises at least one jacking device configured to (i) move the interfacing elements of the handling assembly radially relative to the vertical axis for engaging and/or disengaging a section to be handled, and (ii) move the interfacing elements of the handling assembly vertically for lifting one or more sections of said structure.

The handling system may preferably provide an improved system for bottom-up, sequential erection of an elongate structure, such as a wind tower, from a plurality of consecutive sections thereof (e.g., concrete rings).

Preferably, the jacking arrangement comprises a plurality of jacking devices, each configured to move a respective interfacing element of the plurality of interfacing elements.

The jacking devices may be structurally and spatially separate and may be capable of moving independently, as well as synchronously.

Preferably, the jacking arrangement comprises a bridged arrangement comprising a pair of jacking devices and an intermediate beam spanning therebetween for moving one or more (preferably two) interfacing elements of the plurality of interfacing elements in unison, wherein said one or more interfacing elements are supported on said intermediate beam and wherein the bridged arrangement is configured to provide a clearance zone through which a section of the structure can pass for handling by the jacking arrangement.

With this arrangement, the present disclosure may enable successive sections to be handled without having to deconstruct or significantly rearrange the handling system (e.g., the positions of the jacking devices), thus providing a faster and more efficient system.

Preferably, the intermediate beam comprises two interfacing elements configured to translate horizontally along said beam to vary a horizontal spacing from one another.

Preferably, the bridged arrangement and the plurality of jacking devices are configured to move the interfacing elements radially relative the vertical axis in unison.

With this arrangement, the interfacing elements can preferably engage and/or disengage a section to be handled simultaneously. The bridged arrangement and the plurality of jacking devices may be configured for central and synchronous control (e.g., via a central controller).

Preferably, the interfacing elements are distributed (preferably evenly and/or symmetrically) around a section to be handled and/or around a notional handling system locus (preferably a circle or section thereof).

The interfacing elements may be distributed in a symmetrical arrangement, or in a regular patten. The jacking devices of the jacking arrangement may also be distributed around a section to be handled.

Preferably, the interfacing elements comprise an upright member and a foot member protruding outwardly from a lower end of said upright member for engaging a section to be handled. The interfacing elements may comprise an L-shape.

Preferably, the at least one jacking device comprises an elevation mechanism for moving the interfacing elements vertically.

The elevation mechanism (i.e., a lifting or jacking mechanism) may be configured to lift one or more sections of the structure via the interfacing elements, so as to carry out bottom-up sequential erection of the structure.

Preferably, the elevation mechanism is at least partially housed within a support frame of the jacking device.

The elevation mechanism may be completely housed within the support frame.

Preferably, the elevation mechanism is a screw-type mechanism, such as a roller screw.

Preferably, the elevation mechanism comprises at least one (preferably two) upright threaded rod and a carriage configured to move along the at least one upright threaded rod, wherein the carriage is connected to a respective interfacing element to cause vertical movement of said interfacing element.

Preferably, the elevation mechanism comprises an elevation drive unit configured to rotate the at least one upright threaded rod of the elevation mechanism, such that the carriage moves upwards or downwards along said threaded rod to cause vertical movement of the respective interfacing element.

Hence, the carriage may move relative to the support frame.

Preferably, the at least one jacking device comprises a translation mechanism for moving the interfacing elements radially relative the vertical axis for engaging and/or disengaging a section to be handled.

Preferably, the translation mechanism is further configured to adjust the radial position of the interfacing elements to engage sections of varying diameter.

With this arrangement, the handling system can be used for assembling a structure of non-constant diameter (e.g., a tapering structure).

The translation mechanism may be configured to adjust the radial position of the interfacing elements into a plurality of discrete positions, or on a continuum, and may be configured to lift one or more sections in any of those radial positions.

Preferably, the translation mechanism is or comprises a horizontal slider mechanism.

Preferably, the horizontal slider mechanism comprises a slider frame along which the support frame of the jacking device can move.

Preferably, the slider frame is secured (e.g., bolted) to a foundation.

With this arrangement, the load of the section(s) being handled may preferably be transferred to the foundation.

Preferably, the slider frame comprises a shaft extending longitudinally through a housing and a drive unit configured to actuate the shaft for translation of the support frame along the slider frame.

Preferably, the handling system further comprises a controller configured for synchronous and/or independent control of the jacking devices.

The controller may control the elevation mechanism and/or translation mechanism.

Preferably, the controller is configured to adjust the elevation of the interfacing elements in response to load and/or alignment data.

The handling system may comprise one or more load cells to obtain load data for use by the controller.

Preferably, the handling system further comprises an alignment platform for supporting a lower section of the tower beneath one or more upper sections of the tower being handled by the jacking arrangement, wherein the alignment platform is moveable in a horizontal plane to enable alignment of the lower section with the one or more upper sections.

Preferably, the alignment platform has at least two degrees of freedom including translational and/or rotational degrees of freedom.

Preferably, the alignment platform is moveable freely in the horizontal plane and/or reactively under the influence of an external force such that the alignment platform moves in response to engaging of alignment features of adjacent sections.

Preferably, the alignment platform comprises at least one displacement prop arranged for said movement in the horizontal plane.

Preferably, the at least one displacement prop comprises an upper and lower end, and wherein the upper and/or lower end comprises a spherical ball-joint interface.

The displacement prop may be configured to be self-centering. The displacement prop may be biased to return to a substantially vertical position.

Preferably, the alignment platform comprises a pair of elongate support arms each coupled to one or more carriages via one or more displacement props.

Preferably, the carriages are arranged to travel along rails or tracks for transporting sections of the structure to the jacking arrangement.

Preferably, the alignment platform has an elevation mechanism (such as one or more hydraulic cylinders) for lifting the lower section of the structure into contact with the one or more upper sections.

The alignment platform may have a lifting capacity for lifting one section, e.g., up to 80 tonnes. The hydraulic cylinders of the alignment platform may comprise hydraulic relief values for lowering one or more section of the structure.

Preferably, the elongate structure comprises an elongate tower of a wind turbine installation and optionally wherein the sections of the elongate tower are concrete rings.

A first (upper-most) section of the tower may comprise or be connected to (i.e., mount) a nacelle of the wind turbine installation.

In a second aspect, the disclosure broadly provides a mobile jacking device for handling a section of a structure, the mobile jacking comprising an interfacing element for engaging a section to be handled. The interfacing element comprises (a) a lower engaging portion and upper engaging portion, and (b) a float point about which the engaging portions both freely pivot such that contact and engagement of either of the upper or lower engaging portion with said section causes the other of the upper or lower engaging portion to contact and engage said section. The interfacing element is moveable vertically for lifting said section to be handled and the mobile jacking device is arranged for travelling along the ground.

The mobile jacking device may have any of the features of the jacking devices or movement mechanisms defined in any of the preceding or subsequent statements. Similarly, the interfacing elements may have any features of the interfacing elements defined in any of the preceding or subsequent statements.

The mobile jacking device may comprise a wheel arrangement for travelling along the ground. The wheel arrangement, or other means for ground-based travel of the mobile jacking device, may enable radial positioning of the interfacing elements relative to a section to be handled.

In a third aspect, the disclosure broadly provides a handling system comprising a plurality of mobile jacking devices as defined above, wherein the plurality of mobile jacking devices is configured to cooperate to handle a section of a tower.

The mobile jacking devices may be configured for positioning around a section to be handled.

Preferably, the plurality of mobile jacking devices is arranged for synchronous and/or independent operation.

The plurality of jacking devices may be configured to move or function autonomously.

In a fourth aspect, the disclosure provides a method of assembling an elongate structure from a plurality of sections thereof along a vertical axis using the handling system of any preceding statement, the method comprising:
a) arranging the handling system at an erection site,
b) positioning a first section of the plurality of sections to substantially align with the vertical axis,
c) using the jacking arrangement to move the interfacing elements of the handling assembly towards the first section to engage said first section,
d) using the jacking arrangement to lift the first section along said vertical axis to an elevated position,
e) positioning a second section of the plurality of sections underneath the elevated first section to substantially align with the vertical axis,
f) bringing the first section and second section into contact by lowering the first section towards the second section and/or raising the second section towards the first section, to form a combined portion of the structure, wherein the second section defines a lower section of said combined portion,
g) using the jacking arrangement to move the interfacing elements of the handling assembly away from the first section to release therefrom, and repositioning the interfacing elements to engage the lower section of the combined portion,
h) using the jacking arrangement to lift the lower section along said vertical axis to an elevated position thereby elevating the combined portion,
i) repeating steps e) to h) for consecutively numbered sections so as to add sections in sequence to an iteratively elongating combined portion, thereby assembling the elongate structure from the bottom up.

Preferably, step a) of arranging the handling system comprises securing the jacking devices to a foundation.

Preferably, the step of positioning the second section underneath the elevated first section of step f) comprises providing the second section on the alignment platform defined in any of the preceding statements.

Preferably, step f) comprises lowering the first section using the jacking arrangement, and/or raising the second section using the alignment platform, such that alignment features at a lower end of the first section engage alignment features at an upper end of the second section, wherein said engagement informs horizontal displacement of the second section by virtue of the alignment platform moving freely in the horizontal plane.

Preferably, during step f) the interfacing elements of the jacking arrangement remain substantially engaged to said first section to support a load of said first section.

Preferably, during step f), once both sections are in substantially complete alignment, the alignment platform is lowered into a recess of a foundation, in unison with the vertical lowering of the jacking arrangement to lower said first section, so that the entire weight of said notionally combined portion is imparted onto said foundation.

Preferably, step b) of positioning the first section, and/or step c) of positioning the second section, comprises placing the respective section on the alignment platform and transporting the alignment platform horizontally to said position underneath the respective elevated section.

Preferably, step b) and/or step c) further comprise elevating the bridged arrangement of the jacking arrangement to provide the clearance zone and transporting the alignment platform with the respective section therethrough.

Preferably, the method further comprises transporting the first section and/or second section to the alignment platform using the mobile handling system defined in any preceding statement.

Preferably, the elongate structure comprises an elongate tower of a wind turbine installation.

Preferably, the method further comprises steps of:
j. post-tensioning or otherwise securing together the sections of the combined portion of the structure once it has reached a suitable height; and
k. lowering the combined portion of the structure along the vertical axis until the lower most section comes to rest in a final position below the non-elevated position.

Preferably, step k. comprises:
i. engaging the section of the combined portion of the structure that is currently in the first elevation position;
ii. lowering the notionally combined portion of the structure until the engaged section is in the non-elevated position, and then disengaging the engaged section;
iii. repeating steps i. and ii. for consecutive sections of the combined portion of the structure until the lower most section comes to rest in the final position below the non-elevated position.

Preferably, step k. involves lowering the combined portion of the structure at least partially beneath a water line such that the final position of the lower most section is in a seabed.

Preferably, step k. involves lowering the combined portion of the structure at least partially into a pit such that the final position of the lower most section is in the pit.

In a further aspect, the disclosure provides a method for aligning two sections of an elongate structure being erected along a vertical axis using the handling system of any preceding statement, the method comprising: (a) using the interfacing elements, lifting a first section to an elevated position; (b) using the alignment platform, positioning a second section beneath the first section and substantially in line with the vertical axis; (c) using the alignment platform, lifting the second section toward the first section such that alignment features of the two sections begin to engage; (d) using the alignment platform to tilt the second section such that an upper surface of the second section becomes parallel with a lower surface of the first section; (d) allowing the alignment platform to move in the horizontal plane in response to guiding engagement of the alignment features; (e) optionally, lowering the first and second sections by lowering the interfacing elements and/or alignment platform (f) optionally, releasing hydraulic pressure in the alignment platform via a hydraulic relief valve such that a lower surface of the second section lies parallel with a foundation and the weight of the notionally combined portion is supported by the foundation; (g) optionally, repositioning the interfacing elements to engage the second section; (h) optionally, using the interfacing elements to tilt the notionally combined portion, such that the notionally combined portion realigns with the vertical axis; (i) optionally, using the interfacing elements, lifting the notionally combined portion to an elevated position.

The first section may itself be a notionally combined portion including two or more sections.

The alignment method may be a part of the assembly method described above.

The following additional statements set out further examples of the disclosure. Any of the examples and associated features below may be combined with the statements set out above. In the following, the handling system is referred to as a handling assembly, the jacking arrangement is referred to as a movement arrangement, the jacking device is referred to as a mover mechanism, and the alignment platform is referred to as a displacement platform. Other equivalent terminology with be apparent from the detailed description.

In a further aspect the present disclosure may be said to be a handling assembly for handling a section of a structure comprising: a plurality of spaced apart interfacing elements, each of said plurality of interfacing elements comprising a lower engaging portion and upper engaging portion and a float point about which the engaging portions both freely pivot, wherein the interfacing elements are movable towards and/or away from a section to be handled, so as to enable a coupling thereto and/or release therefrom, wherein, by way of the engaging portions of each interfacing element freely pivoting about their respective float points, contact and engagement of either of the upper or lower engaging portion with said section causes the other of the upper or lower engaging portion to contact and engage said section, and wherein engagement of both upper and lower engaging portions of the plurality of interfacing elements substantially resolves forces across the section to be handled and effectively couples the interfacing elements to and with the section to enable handling of the section by the interfacing elements.

In an example, the interfacing elements spaced apart effectively or substantially evenly or uniformly around a section to be handled and/or around a notional handling assembly locus or periphery.

In an example, the notional handling assembly locus comprises a circular locus.

In an example, the upper and lower engaging portions both freely pivot about the float point in an opposing counterbalanced and/or reciprocal manner.

In an example, free pivoting of the interfacing element about its float point creates a pivoting of either engaging portion in one direction and a responsive pivoting of the other engaging portion in the opposite direction.

In an example, the engaging portions are both mutually hinged and balanced about the float point such that free pivoting of the interfacing element about its float point comprises a pivoting rotation of both engaging portions relative and in opposition to one another.

In an example, free pivoting of the interfacing element about its float point defines translation and/or pivoting of the engaging portions.

In an example, the engaging portions and float point are fixed relative one another.

In an example, the engaging portions and float point are unitarily and/or integrally formed with one another.

In an example, the float point comprises a substantially horizontal pivot axis, such that the interfacing element free pivots about said substantially horizontal pivot axis.

In an example, the float point comprises a curved lower surface defining a curvature radius of the float point.

In an example, a magnitude of the curvature radius defines upper and lower angular limits of the free pivoting of the interfacing element about and relative the float point.

In an example, a magnitude of the curvature radius defines upper and lower angular limits of the free pivoting of the upper and/or lower engaging portions about and relative the float point.

In an example, a vertical and/or horizontal distance of the upper and/or lower engaging portion relative the substantially horizontal pivot axis defines upper and lower angular limits of the free pivoting of the upper and/or lower engaging portions about and relative the float point.

In an example, the lower and upper engaging portions define an upright elongate coupling member extending therebetween.

In an example, the interfacing element comprises an upright elongate coupling member, the upper end of which comprises the upper engaging portion of the interfacing element and the lower end of which comprises the lower engaging portion of the interfacing element.

In an example, the lower engaging portion comprises a pedestal extending outwardly from the coupling member, from a lower end thereof, and the upper engaging portion comprises a pad extending outwardly from the coupling member, from an upper end thereof.

In an example, the coupling member comprises a planar upright surface, the pad comprising a rectangular uniform extrusion from said planar surface and the pedestal comprising a wedge-shaped perturbance extending further outward from said planar surface.

In an example, a vertical and horizontal distance of the centre of mass of the upper engaging portion from the float point, defines a magnitude of free pivoting of the upper engaging portion and/or upper and lower angular limits of the free pivoting of the upper engaging portion about and relative the float point.

In an example, a vertical and horizontal distance of the centre of mass of the lower engaging portion from the float point, defines a magnitude of free pivoting of the lower engaging portion and/or upper and lower angular limits of the free pivoting of the upper engaging portion about and relative the float point.

In an example, planar surfaces of at least parts of the upper and lower engaging portions configured to contact said section to be handled, have a right angle therebetween relative one another, and/or between about 10 degrees to about 170 degrees therebetween relative one another. In an example, planar surfaces of at least parts of the upper and lower engaging portions configured to contact said section to be handled, have an acute angle therebetween, right-angle therebetween or an obtuse angle therebetween relative one another.

In an example, planar surfaces of at least parts of the upper and lower engaging portions configured to contact said section to be handled, have an angle between 0 to 180 degrees relative one another.

In an example, the interfacing elements are configured to be movable radially inwardly and outwardly relative a section to be handled.

In an example, the free pivoting of the upper and lower engaging portions in an opposing counterbalanced and/or reciprocal manner results in contact and engagement of both engaging portions to the section to be handled.

In an example, engagement of both upper and lower engaging portions of the plurality of interfacing elements substantially resolves and counterbalances forces exerted on and/or across the section.

In an example, forces exerted and/or across the section by contact and engagement of either of the upper or lower engaging portion are counterbalanced by forces exerted and/or across the section by contact and engagement of the other of the upper or lower engaging portion with said section.

In an example, forces exerted and/or across an upper part of the section by contact and engagement of the upper engaging portions are counterbalanced by forces exerted and/or across a lower part of the section by contact and engagement of the lower engaging portions.

In an example, contact and engagement of the upper engaging portions to an upper part of the section produces forces at said upper part that are counterbalanced and/or resolved by forces at a lower part of the section produced by contact and engagement of the lower engaging portions to said lower part.

In an example, contact and engagement of the upper engaging portions to an upper part of the section produces tension and/or compression at said upper part that is counterbalanced and/or resolved by tension and/or compression at a lower part of the section produced by contact and engagement of the lower engaging portions to said lower part.

In a further aspect the present disclosure may be said to be a movement arrangement configured for moving the interfacing elements of the handling assembly of the first aspect, comprising at least one mover mechanism configured to move at least one interfacing element of the handling assembly along at least one translational or rotational axis.

In a further aspect the present disclosure may be said to be an apparatus for iterative and sequential erection of an elongate structure from a plurality of sections thereof along a vertical axis, the apparatus comprising: the handling assembly of the first aspect, and a movement arrangement configured for moving the interfacing elements of the handling assembly along the vertical axis and thus action sequential elevation of consecutive notionally numbered sections of the plurality of sections for erection of said structure, the movement arrangement comprising at least one mover mechanism configured to move at least one interfacing element of the handling assembly along said axes.

In a further aspect the present disclosure may be said to be an apparatus for iterative and sequential erection of an elongate structure from a plurality of sections thereof along a vertical axis, the apparatus comprising: a handling assembly for handling a section of said structure, the handling assembly comprising: a plurality of spaced apart interfacing elements, each of said plurality of interfacing elements comprising a lower and upper engaging portion and a float point about which the engaging portions can freely pivot, wherein the interfacing elements are movable towards and/or away from a section to be handled, so as to couple thereto and/or release therefrom during handling, wherein, by way of the engaging portions thereof freely pivoting about their respective float points, contact and engagement of either of the upper or lower engaging portion with said section causes the other of the upper or lower engaging portion to contact and engage said section, and wherein engagement of both upper and lower engaging portions of the plurality of interfacing elements substantially resolves forces across the section to be handled and effectively couples the interfacing elements to and with the section to enable handling of the section by the interfacing elements, a movement arrangement comprising at least one mover mechanism configured to move at least one interfacing element of the handling assembly along said axes, the movement arrangement configured to: move the interfacing elements of the handling assembly towards and/or away from a section to be handled, such that they may couple to and/or release from a given section of the plurality of sections being or to be handled, and move the interfacing elements of the handling assembly along the vertical axis and thus action sequential elevation of consecutive notionally numbered sections of the plurality of sections being or to be handled by the handling assembly, for erection of said structure.

In an example, the mover arrangement is configured to move the interfacing elements radially inwardly or outwardly relative the vertical axis and wherein the mover mechanism is configured to move the interfacing element vertically as well as radially inwardly and outwardly relative the vertical axis.

In an example, the mover arrangement is configured to move the interfacing elements radially inwardly or outwardly relative the vertical axis and/or about or along multiple horizontal translation axes.

In an example, the mover mechanism comprises a support frame supporting at least part of at least one interfacing element, a brace frame to brace said support frame, and a slider frame to permit and/or action translation of said support frame and brace frame along said slider frame.

In an example, the slider frame comprises a slider housing extending longitudinally through which is a slider shaft and connected to said slider shaft is a slider drive unit configured to actuate and/or action translation of the support frame and brace frame relative to and along the slider frame.

In an example, the mover mechanism comprises an elevation mechanism comprising at least one upright elongate threaded rod and a prime carriage coupled thereto both housed partially within and by the support frame.

In an example, the prime carriage is configured to support a lower curved surface of the float point of a respective interfacing element.

In an example, the prime carriage comprises an upper curved surface configured to support a lower curved surface of the float point of a respective interfacing element and at least partially conform to said curved lower surface of the float point of the respective interfacing element.

In an example, a curvature radius of the curved upper surface of the prime carriage is at least partially equal to a curvature radius of the curved lower surface of the float point of the respective interfacing element.

In an example, the curvature radius of the curved upper surface of the prime carriage is smaller than the curvature radius of the curved lower surface of the float point of the respective interfacing element.

In an example, the prime carriage comprises a pin-joint plain bearing, a spherical plain bearing, ball-joint, hinged-joint, floating knuckle and/or axle, having a curvature radius, and configured to support a lower curved surface of the float point of a respective interfacing element.

In an example, the curvature radius is configured to at least partially conform to said curved lower surface of the float point of the respective interfacing element and/or at least partially equal to a curvature radius of the curved lower surface of the float point of the respective interfacing element

In an example, the mover mechanism comprises an elevation drive unit configured to actuate rotation of the at least one upright elongate threaded rod of the elevation mechanism, such that the prime carriage coupled thereto moves upwards or downwards along said threaded rod to thereby action vertical movement of the respective interfacing element.

In an example, a plurality of first mover mechanisms to each move along the vertical axis a respective first interfacing element of the plurality of interfacing elements, as well as a second mover mechanism comprising an intermediate beam supporting at least one second interfacing element of the plurality of interfacing elements, where said beam moves the corresponding at least one second interfacing element along the vertical axis by means of at least one subordinate mover mechanism configured to vertically move said beam along the vertical axis.

In an example, said second mover mechanism comprises two subordinate mover mechanisms, each at respective ends of the intermediate beam and each configured to in unison vertically move an interfacing element supported thereby and coupled to a respective end of the intermediate beam so as to vertically move said beam along the vertical axis and thus vertically move the corresponding at least one second interfacing element supported by said beam.

In an example, the intermediate beam comprises two second interfacing elements configured to translate horizontally along said beam so as to vary a horizontal spacing from one another.

In an example, the intermediate beam comprises horizontal slider slots through and along which said two second interfacing elements are configured to translate horizontally.

In an example, horizontal translation of said two second interfacing elements, together with horizontal translation of both subordinate mover mechanisms at respective ends of the intermediate beam, effect radial inward and outward translation of the two second interfacing elements relative the vertical axis.

In an example, the radial inward and outward translation of the two second interfacing elements relative the vertical axis is actioned or configured in unison with radial inward and outward translation of the first interfacing elements of the plurality of interfacing elements by the plurality of respective first mover mechanisms.

In an example, elevation of the intermediate beam permits clearance zone through which a section to be handled may move to be positioned for handling and vertical movement by the apparatus.

In an example, the handling assembly comprises the handling assembly of the first aspect and/or any one or more of the associated examples.

In an example, the elongate structure comprises an elongate tower of a wind turbine installation, said plurality of sections to be vertically moved along the vertical axis by said apparatus comprising sections of said elongate tower notionally numbered sequentially along the height thereof.

In a further aspect the present disclosure may be said to be a method for iterative and sequential erection of an elongate structure from a plurality of sections thereof along a vertical axis, using the apparatus of the fourth aspect, the sections notionally numbered sequentially along the length of the elongate structure, said method comprising:
a. arranging the apparatus at an erection site of the elongate structure, such that said movement arrangement thereof is supported on, at or atop a foundation of said erection site,
b. positioning a first to-be-upper-most section of the plurality of sections on, at or atop the foundation to substantially align with said vertical axis,
c. actioning the movement arrangement to move the interfacing elements of the handling assembly towards the first section to couple thereto, and coupling said handling assembly to said first section,
d. actioning the movement arrangement to move the first section upward along said vertical axis from a non-elevated position on, at or atop the foundation to a first elevation position,
e. positioning a second section of the plurality of sections underneath the elevated first section, on, at or atop the foundation to substantially align with said vertical axis,
f. actioning the movement arrangement to lower said elevated first section from the first elevation position to atop the second section, to contact and align with said second section so as to form a notionally combined portion of the structure, the second section defining a lower-most section of the notionally combined portion,
g. actioning the movement arrangement to move the interfacing elements of the handling assembly away from the first section to release therefrom,
h. actioning the movement arrangement to move the interfacing elements of the handling assembly downward and then towards the lower-most section of the notionally combined portion to couple thereto, and coupling said handling assembly to said lower-most section,
i. actioning the movement arrangement to move the lower-most section of the notionally combined portion upward along said vertical axis to an elevation position thereby elevating the notionally combined portion,
j. repeating steps c) to i) for consecutive notionally numbered sections so as sequentially add sections to the notionally combined portion, iteratively elevating said notionally combined portion of the structure for each section sequentially added.

In an example, the handling assembly of the apparatus comprises the handling assembly of the first aspect and/or any one or more of the associated examples, and wherein the steps of coupling said handling assembly to said first section and said lower-most section, of steps c) and h) respectively, each comprise moving the interfacing elements such that the pedestals of each lower engaging portion thereof inserts at least partially into section holes of the said first and lower-most sections.

In an example, the steps of coupling said handling assembly to said first section and said lower-most section, of steps c) and h) respectively, each comprise contact and engagement of the upper engaging portions to an upper part of said first and lower-most sections, producing tension and/or compression at said upper part that is counterbalanced and/or resolved by tension and/or compression at a lower part of said first and lower-most sections produced by contact and engagement of the lower engaging portions to said lower part.

In an example, the step of positioning the second section underneath the elevated first section of step f) comprises providing a platform operatively connected to the foundation and configured to displace freely along at least one substantially horizontal translation axis, and placing said second section atop said platform to be supported by said platform.

In an example, the step of lowering said elevated first section to atop the second section, to contact and align with said second section so as to form a notionally combined portion of the structure of step f), comprises:
i. lowering the first section such that alignment features at a lower end thereof become proximate alignment features at an upper end of the second section,
ii. lowering the first section further, so as to initiate an interface between the alignment features of both sections, and continuing to lower the first section such that said interface informs substantially horizontal displacement of the second section by virtue of the platform being configured to displace freely along at least one substantially horizontal translation axis, and
iii. continuing the further lowering of the first section so as to move and guide the second section into alignment with the first section by virtue of said substantially horizontal displacement of the second section, until the alignment features and corresponding ends of both sections are in substantially complete alignment.

In an example, during step f), the interfacing elements of the handling assembly of the apparatus remain substantially coupled to said first section to support a weight and/or load of said first section.

In an example, during step f), once both sections are in substantially complete alignment, the platform may be actuated to vertically lower, such that said platform recesses beneath an upper surface of the foundation, in unison with the vertical lowering of the movement arrangement to lower said first section, so that both first and second sections, now so forming the notionally combined portion, lower onto said upper surface such that the entire weight and/or load of said notionally combined portion is imparted on, and supported by said foundation.

In an example, said platform comprises at least one displacement prop for supporting the platform and operatively connecting it to the foundation from which the platform is supported, wherein at least part of the at least one displacement prop is configured to displace freely along at least one substantially horizontal translation axis so as to permit a free displacement of the platform and thus second section relative the foundation.

In an example, the platform is horizontally movable along recessed slots of the foundation, such that said platform may translate from a position external the apparatus to a position within a notional erection footprint of the apparatus.

In an example, the step of positioning the first section on, at or atop the foundation to substantially align with said vertical axis of step b), and the action of positioning the second section underneath the elevated first section on, at or atop the foundation to substantially align with said vertical axis of step e), each comprise placing the respective section first atop the platform when it is in its position external the apparatus and actuating said platform to move horizontally to its position within a notional erection footprint of the apparatus, so as to position the respective section substantially aligned with said vertical axis.

In an example, the elongate structure comprises an elongate tower of a wind turbine installation, said plurality of sections comprising sections of said elongate tower notionally numbered sequentially along the height thereof, and wherein said first to-be-upper-most section of the plurality of sections comprises at least one of an upper-most section of said tower and/or a nacelle of the wind turbine installation already coupled to a rotor hub of the wind turbine installation.

In a further aspect the present disclosure may be said to be a displacement platform for aligning two sections of a structure being erected, wherein a first lower section of the two sections is supported by the displacement platform, and a second upper section of the two sections is to be lowered atop said lower section for contact and alignment with said lower section, the platform comprising: at least one support arm to support the first lower section thereatop, and at least one displacement prop for supporting the support arm and operatively connecting it to a foundation from which the displacement platform is supported, wherein at least part of the at least one displacement prop is configured to displace freely along at least one substantially horizontal translation axis so as to permit a free displacement of the at least support arm and thus lower section relative the foundation, and wherein the free displacement of the at least one support arm and thus lower section relative the foundation enabling alignment features of the two sections, once interfacing, to inform displacement of the lower most section along said at least one substantially horizontal translation axis so as to move and guide the lower section into alignment with the upper section as it is lowered thereatop.

In an example, a planar platform arranged atop said at least one support arm.

In an example, the at least one displacement prop is operatively connected at one end to said support arm and at another end to the foundation atop which the displacement platform is supported.

In an example, either and/or both ends of the at least one displacement prop is/are configured to displace freely along at least one substantially horizontal translation axis.

In an example, the ends of the at least one displacement prop comprise an upper and lower end, and wherein the upper and/or lower end comprise a spherical ball-joint interface.

In an example, both ends comprise a respective spherical ball-joint interface, such that the upper and lower end of the displacement prop are both configured to displace both translationally and angularly about multiple degrees of freedom.

In an example, the displacement prop is configured to pivot angularly so as to vary an axial angle relative one or more horizontal planes or axes and a vertical plane or axis.

In an example, the at least one displacement prop is configured to displace freely along a plurality of substantially horizontal translation axes.

In an example, the at least one displacement prop is configured to displace freely along a substantially horizontal plane.

In an example, the at least one support arm comprises a horizontally oriented elongate member.

In an example, the displacement platform comprises vertical actuation means which are configured to vertically move the platform relative the foundation.

In an example, the vertical actuation means are configured to lower the displacement platform to within a recess beneath an upper surface of the foundation, as the upper section is lowered atop the lower section, such that the entire weight and/or load of said sections is imparted on, transferred to and/or supported by said foundation, upon completion of said lowering.

In an example, the vertical actuation means comprise a hydraulic arrangement.

In an example, the hydraulic arrangement comprises at least one internal hydraulic jack housed at least partially within a respective at least one displacement prop and connecting at one end to the foundation.

In an example, the hydraulic arrangement comprises a pump configured to pressurise said at least one internal hydraulic jack to lift the displacement platform, and a release valve configured to release said pressure to lower the displacement platform.

In a seventh aspect the present disclosure may be said to be a method of aligning two sections of a structure being erected, wherein a first lower section of the two sections is supported by a platform operatively connected to a foundation of the structure being erected, and a second upper section of the two sections is to be lowered atop said lower section for contact and alignment with said lower section, the method comprising:
a. positioning the first lower section on the platform, beneath and in general alignment with the second upper section,
b. lowering the second upper section such that alignment features at a lower end thereof become proximate alignment features at an upper end of the first lower section,
c. lowering the second upper section further, so as to initiate an interface between the alignment features of both sections, and continuing to lower the second upper section such that said interface informs substantially horizontal displacement of the first lower section by virtue of the platform being configured to displace freely along at least one substantially horizontal translation axis,
d. continuing the further lowering of the second upper section so as to move and guide the lower section into alignment with the upper section by virtue of said substantially horizontal displacement of the lower section, until the alignment features and corresponding ends of both sections are in substantially complete alignment.

In an example, the platform is configured to move vertically, such that, once both sections are in substantially complete alignment, the platform may lower, such that said platform recesses beneath an upper surface of the foundation, so that both sections lower onto said upper surface such that the entire weight and/or load of both sections is imparted on, and supported by said foundation.

In an example, the platform comprises at least one displacement prop for supporting the platform and operatively connecting it to the foundation from which the platform is supported, wherein at least part of the at least one displacement prop is configured to displace freely along at least one substantially horizontal translation axis so as to permit a free displacement of the platform and thus lower section relative the foundation.

In an example, the platform is horizontally movable along, on and/or above the foundation, such that said platform may translate from a position external an erection site where said structure is being erected, to a position within the erection site.

In an example, the step a) of positioning the first lower section on the platform, beneath and in general alignment with the second upper section, comprises placing the respective first lower section first atop the platform when it is in its position external the erection site and actuating said platform to move horizontally to its position within the erection site.

In an example, the structure comprises an elongate tower of a wind turbine installation, said two sections forming part of a plurality of sections comprising sections of said elongate tower notionally numbered sequentially along the height thereof.

In an example, said second upper section of the two sections comprises at least one of an upper-most section of said tower and/or a nacelle of the wind turbine installation already coupled to a rotor hub of the wind turbine installation.

In an example, the platform comprises the displacement platform of the sixth aspect and/or any one or more of the associated examples.

In a further aspect the present disclosure may be said to be a mobile platform interfacing element for handling a section of a structure, the mobile platform interfacing element comprising:
a. a lower engaging portion and upper engaging portion, and
b. a float point about which the engaging portions both freely pivot such that contact and engagement of either of the upper or lower engaging portion with said section causes the other of the upper or lower engaging portion to contact and engage said section,
   the mobile platform interfacing element configured for use with at least one other mobile platform interfacing element as part of a handling assembly, the handling assembly thereby defining a plurality of mobile platform interfacing elements thereof that may each independently move towards and/or away from a section to be handled, and independently position in a spaced-apart manner around the section, so as to enable a coupling thereto and/or release therefrom, wherein engagement of both upper and lower engaging portions of the plurality of mobile platform interfacing elements substantially resolves forces across the section to be handled and effectively couples the interfacing elements to and with the section to enable handling of the section by the mobile platform interfacing elements.

In an example, the mobile platform interfacing element comprises a mover mechanism to move the interfacing element along at least one vertical axis and thus action vertical movement of a section being handled by a handling assembly when said mobile platform interfacing element forms part of said assembly.

In an example, the mover mechanism comprises:
a. a support frame supporting at least part of the interfacing element,
b. an elevation mechanism comprising at least one upright elongate threaded rod and a prime carriage coupled thereto both housed partially within and by the support frame, said prime carriage configured to support a lower curved surface of the float point of the interfacing element, and
c. an elevation drive unit configured to actuate rotation of the at least one upright elongate threaded rod of the elevation mechanism, such that the prime carriage coupled thereto moves upwards or downwards along said threaded rod to thereby action said vertical movement of the interfacing element.

In an example, the mobile platform interfacing element comprises comprising movement means to move the support frame and hence the mobile platform interfacing element horizontally along and on a ground surface, the movement means thereby providing said independent positioning of the interfacing element around a section to be handled and movability towards and/or away from the section.

In an example, said movement means comprises at least one steerable, powered or actuated wheel, track.

In an example:
i. the upper and lower engaging portions both freely pivot about the float point in an opposing counterbalanced and/or reciprocal manner,
ii. said free pivoting of the interfacing element about its float point creates a pivoting of either engaging portion in one direction and a responsive pivoting of the other engaging portion in the opposite direction, and/or
iii. wherein the engaging portions are both mutually hinged and balanced about the float point such that free pivoting of the interfacing element about its float point comprises a pivoting rotation of both engaging portions relative and in opposition to one another.

In an example, free pivoting of the interfacing element about its float point defines translation and/or pivoting of the engaging portions.

In an example, the engaging portions and float point are fixed relative one another and/or wherein the engaging portions and float point are unitarily and/or integrally formed with one another.

In an example, the lower and upper engaging portions define an upright elongate coupling member extending therebetween.

In an example, the lower engaging portion comprises a pedestal extending outwardly from the coupling member, from a lower end thereof, and the upper engaging portion comprises a pad extending outwardly from the coupling member, from an upper end thereof.

In an example, the coupling member comprises a planar upright surface, the pad comprising a rectangular uniform extrusion from said planar surface and the pedestal comprising a wedge-shaped perturbance extending further outward from said planar surface.

In an example, a vertical and horizontal distance of the centre of mass of the upper engaging portion from the float point, defines a magnitude of free pivoting of the upper engaging portion and/or upper and lower angular limits of the free pivoting of the upper engaging portion about and relative the float point.

In an example, a vertical and horizontal distance of the centre of mass of the lower engaging portion from the float point, defines a magnitude of free pivoting of the lower engaging portion and/or upper and lower angular limits of the free pivoting of the upper engaging portion about and relative the float point.

In an example, planar surfaces of at least parts of the upper and lower engaging portions configured to contact said section to be handled, have a right angle therebetween relative one another, and/or between about 10 degrees to about 170 degrees therebetween relative one another.

In an example, planar surfaces of at least parts of the upper and lower engaging portions configured to contact said section to be handled, have an acute angle therebetween, right-angle therebetween or an obtuse angle therebetween relative one another.

In an example, planar surfaces of at least parts of the upper and lower engaging portions configured to contact said section to be handled, have an angle between 0 to 180 degrees relative one another.

In a ninth aspect the present disclosure may be said to be a method for iterative and sequential erection of an elongate structure from a plurality of sections thereof along a vertical axis, the sections notionally numbered sequentially along the length of the elongate structure, said method comprising:
a. positioning a first to-be-upper-most section of the plurality of sections to substantially align with said vertical axis,
b. moving the first section the upward along said vertical axis from a non-elevated position to a first elevation position,
c. positioning a second section of the plurality of sections underneath the elevated first section,
d. lowering said elevated first section from the first elevation position to atop the second section, to contact and align with said second section so as to form a notionally combined portion of the structure, the second section defining a lower-most section of the notionally combined portion,
e. moving the lower-most section of the notionally combined portion upward along said vertical axis to an elevation position thereby elevating the notionally combined portion,
f. repeating steps c) to e) for consecutive notionally numbered sections so as sequentially add sections to the notionally combined portion, iteratively elevating said notionally combined portion of the structure for each section sequentially added.

In an example, the method is carried out by the apparatus of the fourth aspect and/or any one or more of the associated examples.

In an example, the step d) of lowering said elevated first section from the first elevation position to atop the second section, to contact and align with said second section, comprises providing a platform operatively connected to the foundation and configured to displace freely along at least one substantially horizontal translation axis, and placing said second section atop said platform to be supported by said platform.

In an example, the step d) of lowering said elevated first section from the first elevation position to atop the second section, to contact and align with said second section, comprises:
i. lowering the first section such that alignment features at a lower end thereof become proximate alignment features at an upper end of the second section,
ii. lowering the first section further, so as to initiate an interface between the alignment features of both sections, and continuing to lower the first section such that said interface informs substantially horizontal displacement of the second section by virtue of the platform being configured to displace freely along at least one substantially horizontal translation axis, and
iii. continuing the further lowering of the first section so as to move and guide the second section into alignment with the first section by virtue of said substantially horizontal displacement of the second section, until the alignment features and corresponding ends of both sections are in substantially complete alignment.

In an example, the platform is horizontally movable along, on and/or above the foundation, such that said platform may translate from a position external an erection site where said structure is being erected, to a position within the erection site.

In an example, the step a) of positioning a first to-be-upper-most section of the plurality of sections to substantially align with said vertical axis, and the step c) of positioning a second section of the plurality of sections underneath the elevated first section, each comprise placing the respective section first atop the platform when it is in its position external the erection site and actuating said platform to move horizontally to its position within the erection site, so as to position the respective section substantially aligned with said vertical axis.

Any one or more of the examples described above in relation to any one or more of the aspects, may apply to any other of the one or more nine aspects described above.

In this specification, where reference has been made to external sources of information, including patent specifications and other documents, this is generally for the purpose of providing a context for discussing the features of the present disclosure. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

This disclosure may also be said broadly to consist in the parts, elements and features referred to or indicated in the specification of the application, individually or collectively, and any or all combinations of any two or more of said parts, elements or features, and where specific integers are mentioned herein which have known equivalents in the art to which this disclosure relates, such known equivalents are deemed to be incorporated herein as if individually set forth.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

### BRIEF DESCRIPTION OF THE SEVERAL VIEWS OF THE DRAWINGS

The disclosure will now be described by way of example only and with reference to the drawings in which:

FIGS. 1A-C: are perspective views of example handling assemblies.

FIG. 2: is a side view of a first example interfacing element.

FIG. 3: is a perspective view of the first example interfacing element of FIG. 2.

FIG. 4: is a side view of a second example interfacing element.

FIGS. 5A-5C: is a series of schematic side views of an example handling assembly engaging and coupling with a section to be handled.

FIGS. 6A-B: are side and front views of a third example interfacing element.

FIG. 7: is a perspective view of an example handling system.

FIG. 8: is a perspective view of a first example jacking device.

FIG. 9: is a cut-away perspective view of the first example jacking device of FIG. 8.

FIG. 10: is a cut-away side view of the first example jacking device of FIG. 8.

FIGS. 11A-C: are schematic views of a second example jacking arrangement.

FIG. 12A-12H: is a series of schematic side views of an example method of erecting a structure employing an example apparatus.

FIG. 12I: is a perspective view of an example handling system employing an example method of erecting a structure.

FIG. 13: is a cut-away perspective view of an example handling system having an example alignment platform.

FIG. 14: is a perspective view of the example alignment platform of FIG. 13.

FIGS. 15A-15D: are cut-away perspective views of the support arm of the alignment platform of FIG. 14.

FIGS. 15E-15F: are side views of an example displacement prop.

FIG. 16A-16F: is a series of schematic side views of an example method of aligning two sections of a structure.

FIGS. 17A-17F: is a series of side views of a second example method of aligning two sections of a structure.

FIG. 18: is a perspective view of an example handling system applied in an onshore wind turbine installation erection application.

FIGS. 19A-19B: are perspective and section views of an example handling system applied in an offshore marine wind turbine installation.

FIG. 20A-20E: is a series of schematic side views of an example method of erecting a structure and then lowering it into a seabed employing an example apparatus.

FIG. 21: is a perspective schematic view of an example mobile logistics or handling operations vehicle.

FIG. 22: is a perspective schematic view of an example mobile handling system.

FIG. 22A: is a perspective schematic view of an example mobile jacking device.

FIG. 22B-22E: is a series of schematic perspective views of example mobile jacking devices handling various example sections.

### DETAILED DESCRIPTION

The present disclosure broadly relates to a handling system for handling a section of a structure, and methods for erection of a structure, as well as an alignment platform and method for aligning two sections of a structure being erected.

In general, sections of a structure as referred to herein relate to sections (of various forms, configurations and shapes) of structures of substantial magnitude, i.e., civil engineering structures or installations. Preferably, though not exclusively, examples may relate to sections such as rings, columns or towers for wind turbine installations and the like.

Broadly speaking, one aspect of the disclosure provides a handling system for assembling an elongate structure from a plurality of sections along a vertical axis, comprising a plurality of spaced apart interfacing elements—referred to as a handling assembly—for engaging a section of the structure to be handled and a jacking arrangement comprising at least one jacking device configured to move the interfacing elements. The interfacing elements are movable radially relative to the vertical axis for engaging and/or disengaging a section to be handled, as well as vertically for lifting one or more sections of said structure.

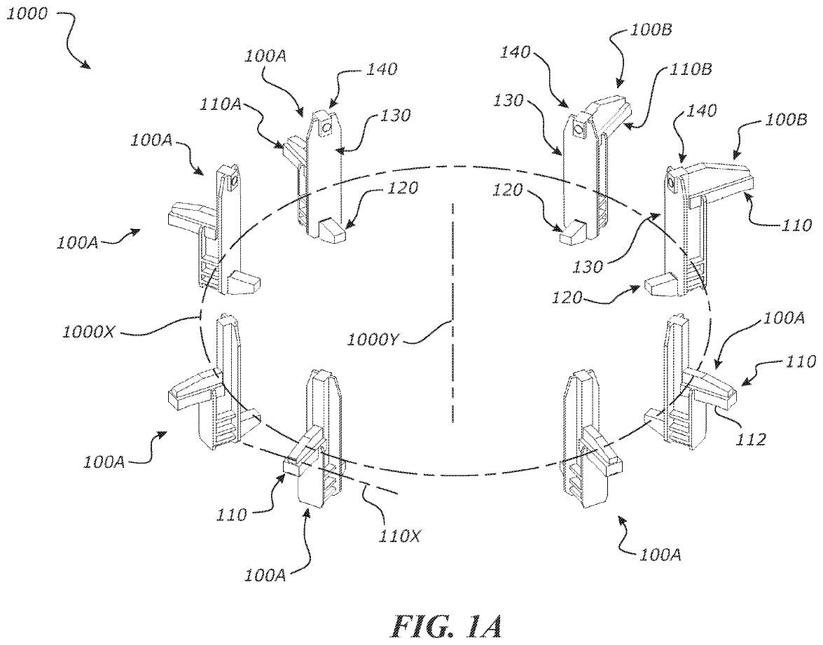

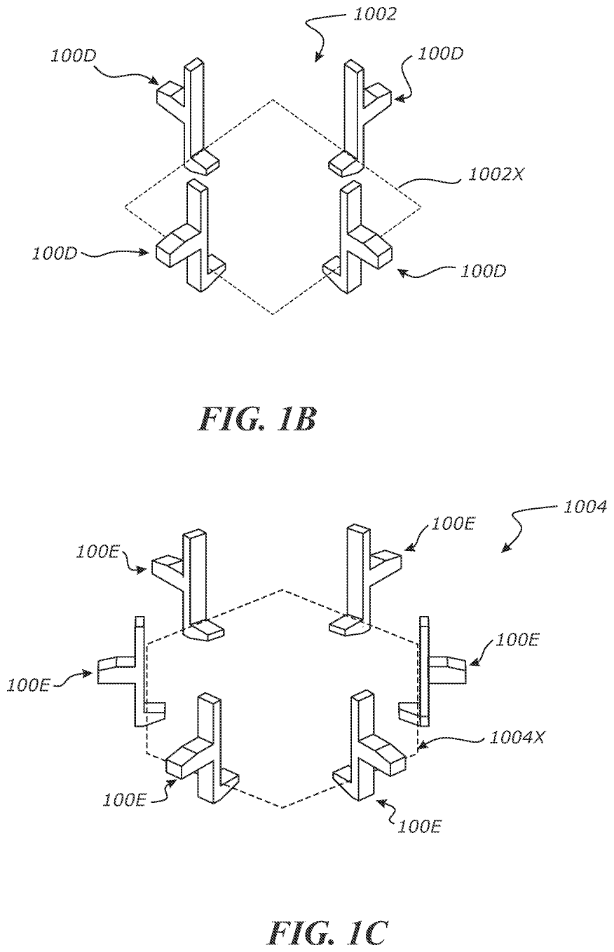

An example handling assembly 1000 for handling a section of a structure is shown in FIG. 1A and is shown to comprise a plurality of spaced apart interfacing elements 100. The interfacing elements 100 are provided for coupling to (i.e., engaging) the sections and carrying the associated load. Generally, the handling assembly is configured such that the interfacing elements are movable towards and/or away from a section to be handled to enable a coupling thereto (and/or release therefrom) during handling, as well as being moveable vertically for lifting (and/or lowering) a section to be handled. This is discussed in further detail later.

Some or all of the interfacing elements 100 may be distributed on a notional circular locus 1000X having a substantially vertical upright axis 1000Y such that its interfacing elements 100 are arranged around/about said circular locus 1000X, equidistant from the centre thereof (defined by said substantially vertical upright axis 1000Y). This circular configuration may suit the handling of circular sections (e.g., concrete rings). Other configurations may be used for handlings sections or objections of a different shape.

In some examples, the interfacing elements 100 are spaced apart substantially evenly or uniformly around which ever particular shape assembly (e.g., notional circular locus) is employed for their positioning. In other examples, such as that illustrated in FIG. 1A, the interfacing elements 100 are arranged into several more closely spaced groups (e.g., pairs, as shown), those groups being distributed evenly or symmetrically.

Eight spaced apart interfacing elements 100 are shown in FIG. 1A, but any number of at least two can be employed for a given handling assembly depending on the application, together with any given distancing or spacing apart between each, depending on a number of requirements specific to any given handling assembly application. FIG. 1B shows an example handling assembly 1002 having four example interfacing elements 100D spaced apart on a square locus 1002X, at each side thereof, for handling, e.g., square or other orthogonal sections. FIG. 1C shows another example handling assembly 1004 having six example interfacing elements 100E spaced apart on a hexagonal locus 1004X, at each side thereof, for handling, e.g., hexagonal or other polygonal sections. A different handling assembly configuration, for instance for the handling of orthogonal sections or objects, could employ two interfacing elements positioned to handle sections or objects at only two opposing faces of four faces thereof, or four interfacing elements positioned to handle sections or objects at all four faces thereof. Generally, a polygonal or circular locus may be employed with the number of interfacing elements defined by the number of faces of a particular polygonal shape or shape(s).

Each of said plurality of interfacing elements comprises a lower engaging portion in the form of an outwardly protruding foot member for engaging a section to be handled (e.g., for engaging a pocket-like recess in said section).

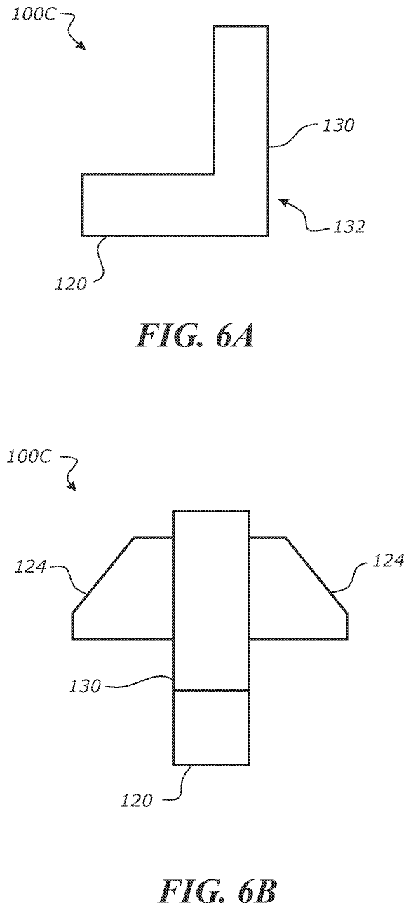

In this first example handling assembly 1000 shown in FIGS. 1A-5C, each interfacing element 100 includes a lower engaging portion 120 (i.e., the foot), an upper engaging portion 140 (i.e., a pad) and a float point 110 about which the engaging portions 120, 140 can both freely pivot. With this arrangement, the interfacing elements are arranged to grip, or clamp, a section being handled and may cooperate to substantially resolve forces across the section being handled. An alternative, non-clamping example is shown in FIGS. 6A-B.

In the first example handling assembly 1000, the pivoting may be in an opposing counterbalanced and/or reciprocal manner, in that free pivoting of the interfacing element 100 about its float point 110 creates a pivoting of either engaging portion in one direction, e.g., clockwise and a responsive pivoting of the other engaging portion in the opposite direction, e.g., counterclockwise. The extent to which one engaging portion moves or pivots relative to the other may be determined or defined by a number of factors. The pivoting may also be described as a rocking motion about the float point, a harmonic pivoting/rotation of both engaging portions relative and in opposition to one another by virtue of their mutual hinged balancing about the float point.

The free pivoting of the interfacing element 100 about its float point 110 may generally define the pivoting movement of the engaging portions 120, 140, wherein free pivoting of the interfacing element 100 about its float point 110 defines translation and/or pivoting of the engaging portions thereof. This may be achieved in a number of ways, and in this example handling assembly 1000 shown in FIGS. 1 to 5C, is provided at least by having the interfacing elements 100 being integrally formed unitary components, where said engaging portions 120, 140 and float point 110 are not movable relative to one another by virtue of their structurally unified form. The upper and/or lower engaging portion(s) 120, 140 of example handling assembly 1000 are thus fixed relative the float point 110. In other examples, the upper and/or lower engaging portion(s) may be movable relative the float point and each other, i.e., not unitarily or integrally cast, formed or assembled but nonetheless still possessing a reciprocal pivoting relationship about the float point.

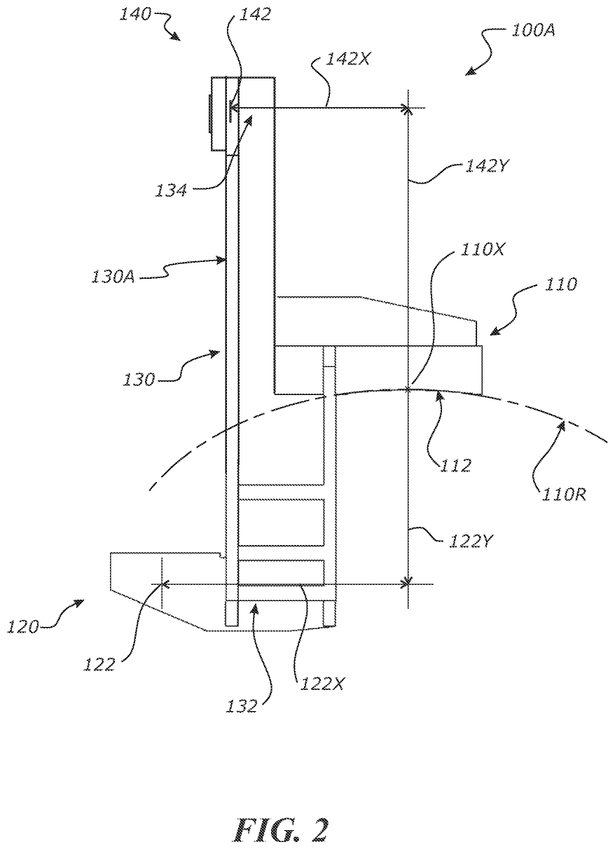

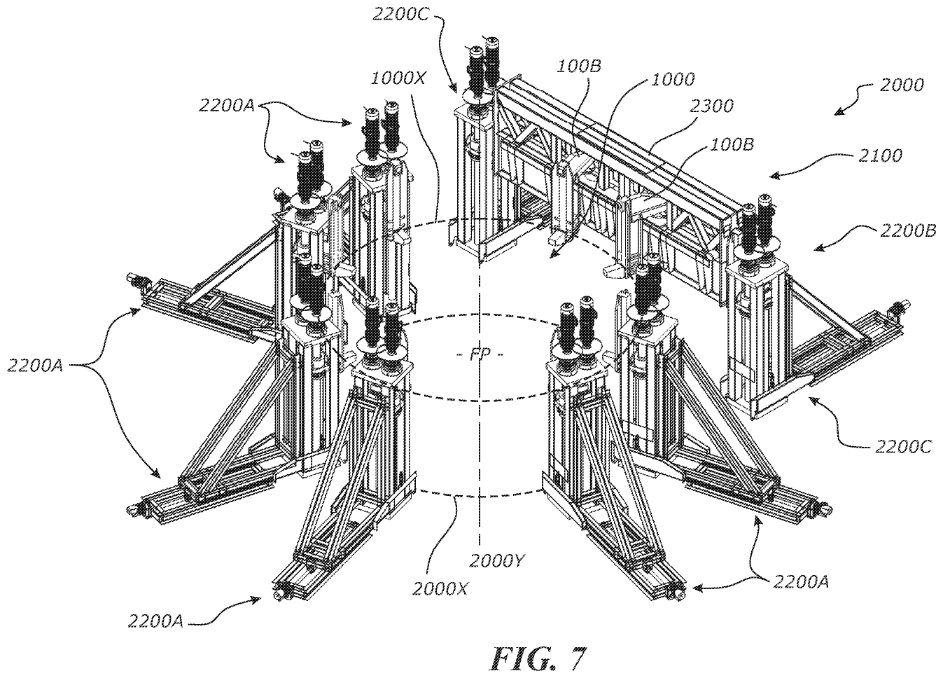

The float point 110 of an example first interfacing element 100A in FIG. 2 is shown having a substantially horizontal pivot axis 110X, being a substantially horizontal pivot axis extending ‘into the page’. The float point may be a point on which the interfacing elements balance such that the engaging portions hinge about the float point. The float point 110 is also shown comprising a curvature radius 110R, being the curvature radius of a curved lower surface 112 of the float point 110, i.e., the notional radius of a notional arc defining said curved lower surfaces 112 shape. The feature, i.e., structural item upon which the curved lower surface 112 floats, rests, or is otherwise supported and pivots upon, will be described in further detail below in relation to certain examples of the present disclosure, such as for example apparatus 2000 of FIGS. 7 to 11 which employs the example handling assembly 1000 of FIG. 1.

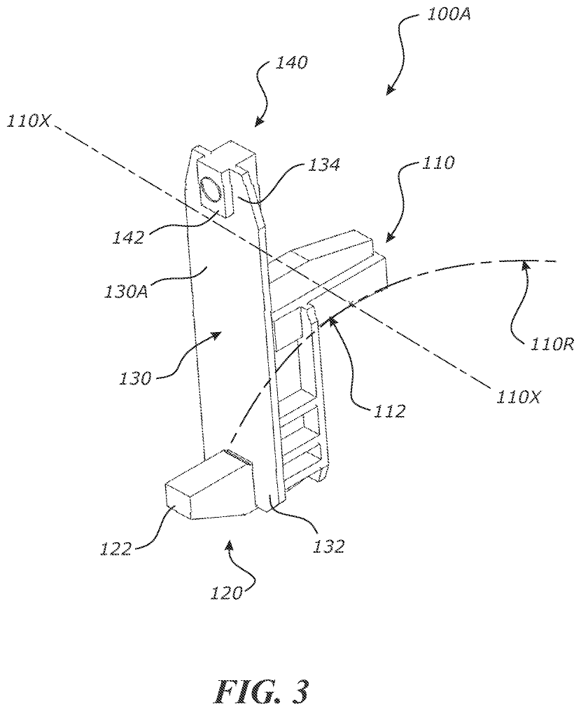

FIG. 3 shows said example first interfacing element 100A in perspective, where said curvature radius 110R and substantially horizontal pivot axis 110X are also shown. The magnitude of the curvature radius 110R may define the free pivoting behaviour of the first interfacing element 100A. The orientation of the pivot axis 110X may also define at least part of the free pivoting behaviour of the first interfacing element 100A. In some embodiments, the pivot axis 110X may not be substantially horizontal. In any case, it will be appreciated that by virtue of said float point 110 balancing on the lower curved surface 112 the curvature radius 110R and the pivot axis 110X may define or determine the pivoting behaviour, i.e., extent of pivoting of interfacing element 110A as a whole, as well as its constituent engaging portions 120, 140. It will be further appreciated that the pivoting behaviour of either engaging portion, or both, or their pivoting relative one another, may be determined by their horizontal and vertical distance from one another, as well as from the pivot axis 110X. The relative size and mass of the engaging portions 120, 140 may also influence their relative pivoting motion.

The lower and upper engaging portions 120, 140, at least for said interfacing element 100, define a coupling member (i.e., elongate portion) 130 extending therebetween. The lower engaging portion 120 is shown to comprise a foot or pedestal 122 extending outwardly from the coupling member 130, in particular from a lower end 132 thereof. The upper engaging portion 140 comprises a pad 142 extending outwardly from the coupling member 130, in particular from an upper end 134 thereof.

The coupling member 130 in both interfacing element examples 100A, 100B is shown comprising a planar upright surface 130A, the pad 142 comprising a rectangular uniform extrusion from said planar surface 130A, and the pedestal 122 comprising a wedge-shaped perturbance extending further outward from said planar surface 130A. The shapes and sizes of said pad 142 comprising a rectangular uniform extrusion and said wedge-shaped perturbance can both vary in some configurations, together with the extent to which they extend outward from said planar surface 130A. The shapes and sizes of the float point 110 and coupling member 130 may also vary to suit a certain configuration, or desired pivoting behaviour.

A vertical and horizontal distance 142Y, 142X of the centre of mass of the pad 142 from the pivot axis 110X is shown in FIG. 2 together with a vertical and horizontal distance 122Y, 122X of the centre of mass of the pedestal 122 from the pivot axis 110X. The vertical and/or horizontal distance 142Y, 142X of the centre of mass of the pad 142 from the pivot axis 110X may define the magnitude of pivoting (rotation and/or translation) of the upper engaging portion 140 relative that of the lower engaging portion 120. Conversely, the vertical and/or horizontal distance 122Y, 122X of the centre of mass of the pedestal 122 from the pivot axis 110X may define the magnitude of pivoting (rotation and/or translation) of the lower engaging portion 120 relative that of the upper engaging portion 140.

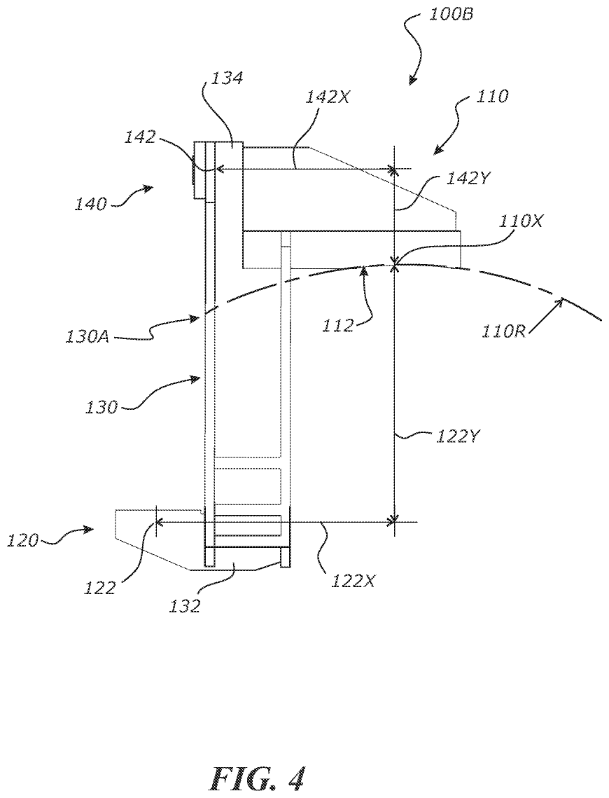

FIG. 4 shows an example second interfacing element 110B, having all the same features as described above in relation to the first example interfacing element 110A of FIGS. 2 and 3, as indicated by the use of identical reference numerals, with one notable difference being the float point 110 configured higher up towards the upper end 134 of the coupling member 130, and thus, these vertical and/or horizontal distances 122X, 122Y, 142X, 142Y of the pedestal 122 and pad 142 from the pivot axis 110X being different. In particular, the vertical and/or horizontal distance 142Y, 142X of the centre of mass of the pad 142 from the pivot axis 110X of said example second interfacing element 110B is much smaller than that of the first interfacing element 110A. This may result in different pivoting behaviours of said second interfacing element 110B compared to said first example interfacing element 110A.

Planar surfaces of at least parts of the upper and lower engaging portions configured to contact said section to be handled may have a right angle therebetween relative one another, and/or between about 10 degrees to about 170 degrees therebetween relative one another. In the example interfacing elements 100A, 100B described above, the planar surfaces may be the planar vertical surface of the pad 142 and the planar horizontal upper surface of the wedge-shaped pedestal 122 for the upper and lower engaging portions 120, 140. The angle between said surfaces may be a right-angle (about 90 degrees). In other examples, said planar or contact surfaces of at least parts of the upper and lower engaging portions, such as the pads, pedestals or one or more surfaces configured to contact and engage at least part of a surface of said section to be handled, may have an acute angle therebetween, right-angle therebetween or an obtuse angle therebetween relative one another, or have an angle between 0 to 180 degrees relative one another.

It will be understood that various features of the interfacing elements described above may be configured as desired to influence or define the pivoting behaviour, that is, the rocking motion about the float point. It will also be appreciated that the amount of contact, i.e., surface area, of a given engaging portion may vary from the example interfacing elements and how they are configured as well as the surfaces of parts of features of sections to which they contact and engage with. For instance, a contact surface of upper engaging portion may extend beyond just the pad 142 in instances where the pivot angle is minimal and a more substantial portion of the upper end of the coupling member contacts and presses against a section wall, for example. Distances from one another, described in relation the above features, may also influence certain characteristics of the coupling action, force resolution, counterbalance of forces/moments, and other engaging/handling aspects of the present disclosure, as will described further below.

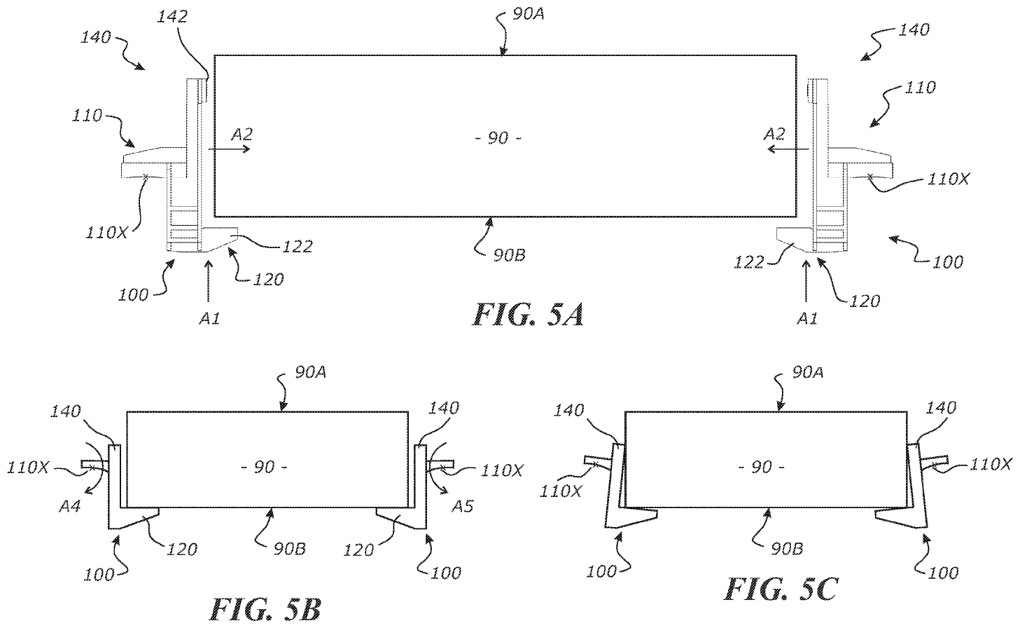

It is noted that the free-pivoting behaviour about the floating contact point is optional and any of the above features may be present without a free-pivoting float point. Nevertheless, for the purposes of the present discussion, it will be appreciated that by way of the engaging portions (of the plurality interfacing elements) freely pivoting about their respective float points, contact and engagement of either of the upper or lower engaging portion with said section causes the other of the upper or lower engaging portion to contact and engage said section such that the interfacing elements effectively grip a section being handled when under load, thereby resolving forces across the section. This is illustrated in FIGS. 5A to 5C with relation to the example handling assembly 1000 described thus far.

In FIG. 5A, a section 90 (of a structure) to be handled is shown, having upper surface 90A, lower surface 90B, and sides 90C, for example. For the purposes of illustration, the section 90 is handled by two interfacing elements 100 (being first interfacing elements 100A of FIGS. 2 and 3) of the example handling assembly 1000. Arrows A1 and A2, A3 respectively illustrate the two elements 100 moving towards the section 90 both upwardly, such that lower engaging portions 120, and their constituent pedestals 122 move towards lower surface 90B of the section 90, and laterally towards the sides 90C of the section 90, such that elements 100 move generally towards the section 90 (specifically, pads 142 of upper engaging portions 140 as well as the coupling members 130 move towards said sides 90C of the section 90).

In FIG. 5B, the lower engaging portions 120 (specifically the pedestals 122) have contacted and engaged with the section 90, at or to at least the lower surface 90B. Due to the counter-pivoting relationship of the upper and lower engaging members 120, 140, this contact, together with further upward movement in direction A1, causes a pivoting response of the interfacing elements 100 (clockwise and counter-clockwise rotation, respectively, along pivot arrows A4, A5) about their float points 110 and respective pivot axes 110X. The response of said pivoting is the rotation of the upper engaging portions 140, and their pads 142, towards the sides 90C of the section 90, such that they contact and engage said section 90, as shown in FIG. 5C. Hence, the contact and engagement of lower engaging portions 120 causes a pivoting response about float points 110A, causing contact and engagement of the upper engaging portions 140.

Other handling assemblies may have a different order of movement and contact that results in engagement of both engaging portions to the section, such as for example an initial contact and engagement of the upper engaging portions, by way of inward, upward and/or downward movement relative the section, causing resultant contact and engagement of the lower engaging portion by way of further inward, upward and/or downward movement relative the section. An alternative interfacing element may have the pedestals 122 and pads 142 inverted, such that the pedestals 122 are located at the upper engaging portion 140 and pads 142 at the lower engaging portion 120. In such case, the interfacing elements may instead by lowered initially, together with inward lateral movement towards the section, to first cause a contact and engagement of the pedestals to the top surface of a section followed by and resulting in pivoting and thus contact and engagement of the pads to the sections sides.

The example steps of FIGS. 5A to 5C are hence illustrative only.

The engagement of the either first of the engaging portions to the section, may cause a compressive force or load to act on the section. Once the other of the engaging portions engages to the section, a tensile force or load may be imparted which counteracts and resolves the compressive force initially created. Hence, engagement of both upper and lower engaging portions of the plurality of interfacing elements, to a section, may substantially resolve forces across the section and effectively couple the interfacing elements to the section to enable handling of the section by the interfacing elements. In other words, once a section is appropriately engaged by both engaging portions of the interfacing elements, the interfacing elements operatively couple to the section in a manner that allows the handling assembly to move the section in unison with its own movement. For example, once the handling assembly 1000 example of FIGS. 1 to 5C has engaged and coupled to a given section, the collective movement of the interfacing elements, such as by connection to an outer structure (e.g., system 2000 of FIG. 7), moves the section with the handling assembly 1000.

It will further be appreciated that forces exerted and/or across an upper part of the section by contact and engagement of the upper engaging portions may be counterbalanced by forces exerted and/or across a lower part of the section by contact and engagement of the lower engaging portions, wherein contact and engagement of the upper engaging portions to an upper part of the section produces forces at said upper part that are counterbalanced and/or resolved by forces at a lower part of the section produced by contact and engagement of the lower engaging portions to said lower part, and/or that contact and engagement of the upper engaging portions to an upper part of the section produces tension and/or compression at said upper part that is counterbalanced and/or resolved by tension and/or compression at a lower part of the section produced by contact and engagement of the lower engaging portions to said lower part. This occurs in part due to the opposing counterbalance of the interfacing elements about their float points 110 or float axes 110X, whereby any force or moment exerted upon the section at one part/area thereof is counteracted by an equivalent force or moment exerted at another part/area once the other engaging portion acts thereon. It will also be appreciated, that this resolution of forces may occur across opposing interfacing elements, and that distributing interfacing elements around a section to be handled in an at least partially evenly spaced-apart manner is preferable so that forces produced are distributed and thus resolved uniformly across/around the section. Thus, while a handling assembly may comprise any plurality of interfacing elements, i.e., two or more, these are preferably distributed around an outer periphery of the section so that forces or moments acting on the section during engagement and coupling of the interfacing elements is evenly distributed and thus evenly resolved or counteracted and thus neutralised. In other words, interfacing elements are preferably distributed around a section to be handled in a manner that provides uniform force distribution.

The above discussion describes an example that uses freely pivoting interfacing element having first and second engaging portions that act to clamp and grip a section when under load and resolve forces across the section. However, in other examples the interfacing elements may not be configured in this way. One simplified example of a non-clamping interfacing element 100C is shown in FIGS. 6A-B. Like the previous interfacing elements, the interfacing element 100C comprises an upright elongate portion 130 and a foot member 120 protruding outwardly from a lower portion 132 thereof (the foot member 120 being arranged to engage and carry the load of a section to be handled, preferably shaped for insertion into a pocket-like feature of the section). However, in this case, the interfacing element is secured or supported in a non-pivoting manner. A front view of the interfacing element is shown in FIG. 6B, which shows flanges 124 for securing the interfacing element 100C to the jacking devices (the prime carriages of the elevation mechanism, which are discussed below). Otherwise, the interfacing elements 100C may have any of the features already discussed.

As mentioned, the handling assembly is part of a handling system in which the interfacing elements are moveable load-carrying components. Shown in FIG. 7 is an example handling system 2000 (which may also be referred to as an apparatus) including a plurality of interfacing elements. In this example, and those that follow, the handling system is described and shown using the free-pivoting (‘clamping’) interfacing elements 100A, 100B of FIGS. 1-5. However, this is just one example used to illustrate potential applications and advantages of the handling assembly. It will be appreciated that the handling system could instead use non-clamping interfacing elements, such as those of FIGS. 6A-B.

The handling system 2000 may be used for the ‘bottom-up’ iterative and sequential erection of an elongate structure from a plurality of sections thereof along a vertical axis 2000Y. The vertical axis may coincide generally with that of the elongate structure once erected. The erection may take place on an erection footprint FP at the final installation site of the structure. The erection footprint may be defined by the area of a foundation within the jacking arrangement where a given structure is to be erected. The erection footprint may be informed by the peripheral shape of a given plurality of interfacing element(s) and/or a given plurality of jacking devices of a given system (e.g., a circle or polygonal or orthogonal shape, etc., having a diameter, circumference, radius etc). The erection footprint may define a notional area or zone encompassed by the interfacing elements, handling assembly and/or jacking arrangement of a given handling system. It may correspond generally to a variable or adjustable locus or periphery (such as for instance notional circular locus 1000X of FIG. 1) of the interfacing elements, handling assembly, jacking arrangement and/or jacking devices for a given system.

The illustrated system 2000 comprises the example handling assembly 1000 of FIGS. 1 to 5C. It thus comprises of a handling assembly 1000 having interfacing elements 100 in a substantially circular arrangement (on a circular locus) to suit the handling of circular sections of said elongate structure. The elongate structure may be, for example, a tower, such as a tower of a wind turbine.

Handling system 2000 also comprises a jacking arrangement (also referred to as a movement arrangement) 2100 configured to move the interfacing elements of an associated handling assembly towards and/or away from a section to be handled, such that they may couple to (i.e., engage) and/or release (i.e., disengage) from a given section of the plurality of sections being or to be handled, and configured for moving (i.e., lifting) the interfacing elements of the handling assembly along the vertical axis 2000Y and thus action sequential elevation of consecutive notionally numbered sections of the plurality of sections to be assembled by the handling system for erection of the structure.

To that end, the jacking arrangement 2100 comprises at least one jacking device (also referred to as a mover mechanism) 2200 configured to move (i.e., lift) at least one interfacing element 100 of the handling assembly 1000 along said vertical axis 2000Y.

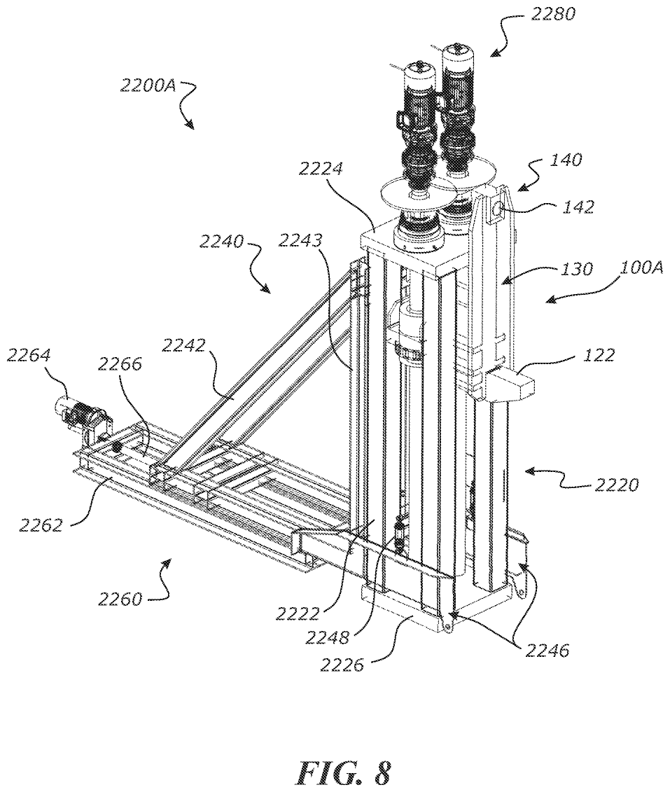

A first example jacking device 2200A is shown in FIGS. 8 to 10. It comprises a support frame 2200 supporting at least part of the first example interfacing element 100A described previously, a brace frame 2240 to brace said support frame 2200, a slider mechanism 2260 and a roller screw mechanism 2290. The slider mechanism is one example of a translation mechanism arranged to enable radial movement and positioning of the interfacing elements for engaging and disengaging a section, and adjusting the radial position of the interfacing elements for engaging sections of varying diameter. The slider mechanism comprises a slider frame 2260 for translation of said support frame 2200 and brace frame 2240 along said slider frame 2260. The roller screw mechanism is one example of an elevation mechanism for raising (and lowering) the interfacing elements for lifting of the sections.

The support frame 2200 comprises of vertical upright bars 2222 sandwiched between an upper plate 2224 and lower plate 2226. The support frame 2200 is a unitary assembly in that said upright bars 2222 and lower and upper plates 2224, 2226 do not move relative one another. The support frame 2200 provides a partial housing for support of vertical movement of the interfacing element 100A.

The brace frame 2240 comprises triangular right-angled brace members 2242 extending to brace plates 2246 that flank either side of a lower end of the support frame 2200. The upright bars 2243 of the brace members 2242 are proximate the vertical upright bars 2222 of the support frame 2200. Brace members 2242 thereby help to brace the support frame 2200 against deflection and deformation experienced by and during handling operations of the apparatus 2000.

During movement of the interfacing elements 100 vertically relative the support frame 2200, said support frame 2200 will preferably be supported on the ground (e.g., on a foundation). A pair of frame actuators 2248 may be provided for connecting support plates 2228 that extend between the upright bars 2222 of the support frame 2200 to the brace plates 2246 of the brace frame 2240 that flank either side of a lower end of the support frame 2200. The actuators 2248 may be actuated to elevate the support frame 2200 sufficiently from the ground or foundation. This can enable horizontal movement of the support frame 2200, by virtue of horizontal translation of the brace frame 2240 along the slider frame 2260.

The slider frame 2260 comprises a slider housing 2262 having a slider drive unit 2264, such as for example a DC or AC motor coupled to a gearbox. Extending longitudinally through the slider housing 2262 is a slider shaft 2266 which, by way of the drive unit 2264, actuates translation of the brace frame 2240 along and relative to the slider frame 2260. Preferably, the slider frame 2260 (e.g., slider housing 2262) is secured (e.g., bolted) to the foundation to resist or counteract the load carried by the interfacing element, and resolve forces acting at the base of the structure into the foundation. This may be particularly preferable where the interfacing elements are not the free-pivoting type (e.g., with the interfacing elements 100C of FIG. 6A-B).

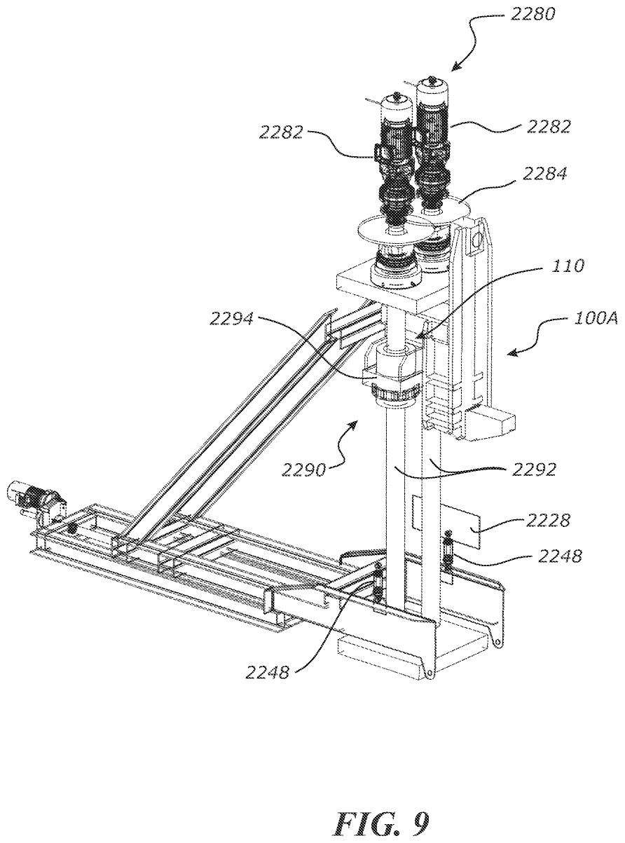

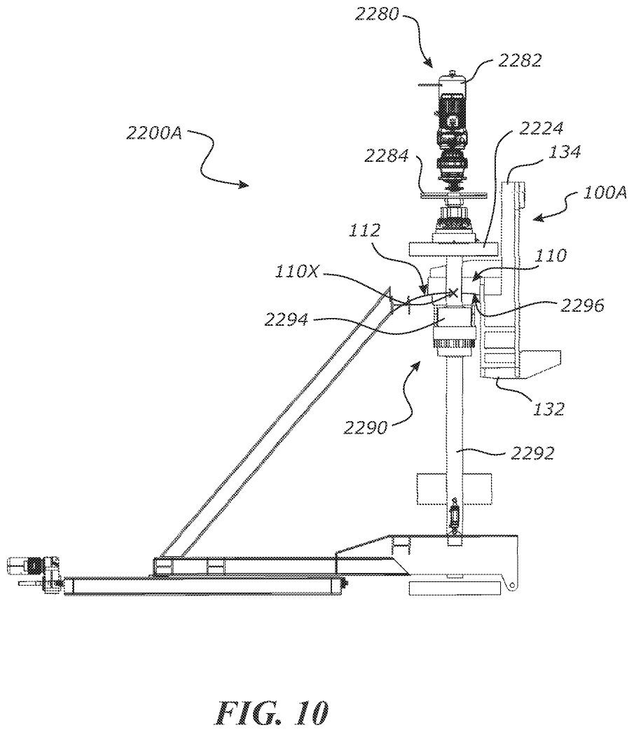

An example of an elevation mechanism 2290 for moving the interfacing element 100A of a jacking device vertically is shown in FIGS. 9 and 10 in the form of a roller screw (the support frame 2220 vertical upright bars 2222 are hidden for clarity). The elevation mechanism 2290 comprises elevation drive unit 2280 having a pair of DC or AC motors 2282 with appropriate gearbox arrangements coupled to respective pair of threaded rods 2292 of the elevation mechanism 2290. Actuation of said motors 2282 causes the threaded rods 2292 to rotate, causing prime carriage 2294 of the elevation mechanism 2290 to move upwards or downwards (via internal threads of said carriage 2294, not visible in FIGS. 9 and 10). Brake units 2284, such as disk brakes, are also shown, which may be used during an emergency to slow or halt actuation of the elevation mechanism 2290 by the motors 2282.

The prime carriage 2294 may provide the feature, i.e., structural item, upon which the curved lower surface 112 of the float point 110 of the first example interfacing element 100A floats, is supported by, and pivots upon and about. In other examples (e.g., the example of FIGS. 6A-B), the interfacing element may be connected (such as via flanges 124), coupled or integrally formed with the prime carriage, such that movement of the prime carriage causes corresponding movement of the interfacing element.

The elevation mechanism 2290 (e.g., the threaded rods 2292, prime carriage 2294 and/or motors 2294) may be wholly or partly housed within the support frame 2220 of the jacking device 2200. In particular, the prime carriage 2294 may move vertically within (and relative to) the support frame 2220, Some or all of the interfacing element 100A may also be housed within the support frame.

Hence, the jacking device 2200A facilities the vertical movement of the interfacing element 100A, as well as inward and outward (i.e., radial) translation of the interfacing elements relative the vertical axis 2000Y. Preferably, the translation mechanism is configured to adjust the radial position of the interfacing elements to engage sections of varying diameter. With this arrangement, the handling system can be used for assembling a structure of non-constant diameter (e.g., a tapered structure). The translation mechanism may be configured to adjust the radial position of the interfacing elements into a plurality of discrete positions, or on a continuum, and may be configured to lift one or more sections in any of those radial positions. Yet other jacking arrangements may be configured to move the interfacing elements of the handling assembly about multiple horizontal translation axes. Those skilled in the art will recognise the example jacking device 2200A as illustrating but one possible arrangement for enabling the desired movement of interfacing elements of the handling assembly along the vertical axis, as well as movement of interfacing elements of the handling assembly radially inwardly or outwardly to facilitate the movement of the interfacing elements towards and/or away from a section to be handled so that they may contact, engage and then couple thereto and/or release therefrom as and when desired.

In FIG. 10, the pivot axis 110A of the free-pivoting interfacing elements previously described is shown to extend across the prime carriage 2294, with curved lower surface 112 of the float point 110 of the interfacing element 100A resting and pivoting upon curved upper surface 2296 of the prime carriage 2294. Curved lower surface 112 of the float point 110 and curved upper surface 2296 of the prime carriage 2294 may hence be configured to at least partially conform to one another, and thus support the float point 110. A curvature radius of the curved upper surface 2296 of the prime carriage 2294 may at least partially match that curvature radius 110R of the curved lower surface 112 of the float point 110. Preferably, the curvature radius of the curved upper surface 2296 of the prime carriage 2294 is smaller than that of the curved lower surface 112 of the float point 110.

This is but one example of how a float point interface may be configured. Other known engineering joints or connections may be employed to achieve a free-floating pivoting interface. For example, a pin-joint plain bearing, mounted to a substantially horizontal axle, may be used in lieu of the curved upper surface 2296 of the prime carriage 2294. Here, the curvature radius, or rather simply the radius, of the plain bearing may be configured in view of the geometric characteristics of the curved lower surface 112 of the float point 110, to pursue a desired pivoting behaviour of the interfacing element 100A. Alternatively, a spherical plain bearing may be employed in lieu of the curved upper surface 2296 of the prime carriage 2294 to provide free floating pivoting of the float point 110 about a larger degree of freedom. The curvature radius, width, depth and other geometric characteristics of the feature upon which the float point 110 pivots, such as curved upper surface 2296 of the prime carriage 2294 may, together with those of the curved lower surface 112 of the float point 110, be varied, adjusted and/or configured to suit a desired pivoting behaviour of the interfacing element 100A. In other examples, the float point may comprise any other suitable engineering joint, such as a ball-joint, hinged-joint, floating knuckle, and the like, which may appropriately be configured to provide a floating, hinged, pivot or balance point. Those skilled in the art may also envisage means of lubrication, greasing together with use of bearings and the like that may be desirable when assembling said float point, so as to satisfy service life, safety, engineering and other operational or regulatory requirements.

Further, while free pivoting has been used to describe the free-floating movement of the interfacing element about its float point and pivot axis, the physical structures and componentry surrounding the interfacing element together with the configuration of the prime carriage and/or the interfacing element itself may define upper and lower pivot limits for the upper and lower engaging portions. For instance, the curvatures of the curved upper surface 2296 of the prime carriage 2294 and curved lower surface 112 of the float point 110 may be configured to create an inherently higher resistance to pivoting at extremes of the pivoting range of motion. Moreover, contact of the interfacing element 100A, such as of the upper and lower ends 132, 134 of the coupling member 130 thereof, with the support frame 2220, or the prime carriage 2294, could define upper and lower pivot limits for the upper and lower engaging portions 120, 140 that prevent further pivoting at said limits.

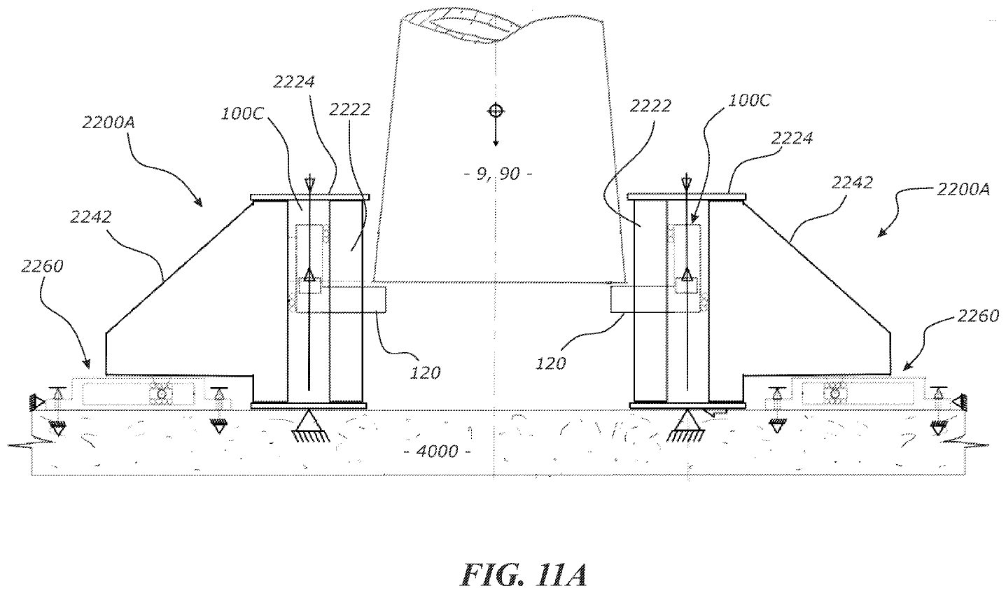

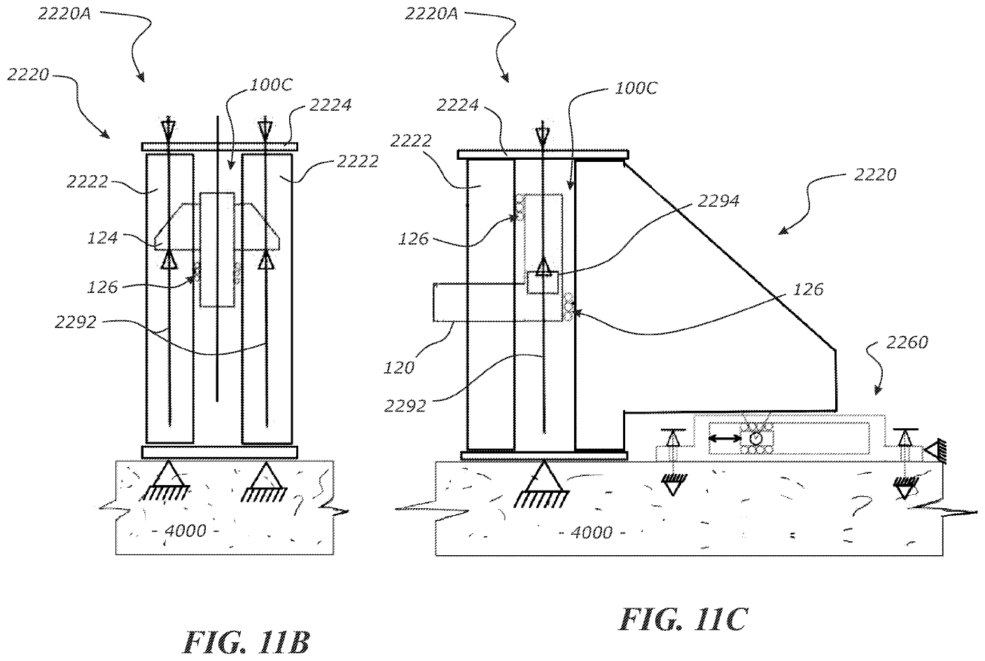

In the case of non-freely pivoting interfacing elements, such as those illustrated in FIG. 6A-B, it may be desirable to effectively transfer loads from the interfacing elements to the foundation to resolve forces. FIG. 11A shows schematic view of an example jacking arrangement having the alternative interfacing elements 100C of FIG. 6A-B, illustrating the load path to the foundation 4000. The jacking devices 2200A are shown independently in FIGS. 11B-C. The relevant forces acting at each point are illustrated by arrows. Besides the configuration of the interfacing elements and the specific difference discussed below, the jacking devices may have any of the features of the jacking device 2200A described previously, and common components are denoted with the same reference numerals. Some features are omitted for clarity of illustration.

Here, the upright elongate portion of the interfacing element is disposed within the support frame 2220 of the jacking device and coupled (e.g., connected directly or indirectly, such as via flanges) to the prime carriage 2994 of the elevation mechanism 2290 to move vertically with the carriage 2994 within the support frame 2220. The interfacing element may be further supported by the support frame 2220 via bearings, rollers or the like 126 that transfer load from the interfacing elements 100C to the support frame 2220 whilst allowing relative vertical movement of the two components. The bearings 126 may be positioned for the intended load transfer path. For example, as shown in FIGS. 11A and 11C, a first bearing may support a radially inner side of an upper end of the upright elongate portion of the interfacing element, and a second bearing may support a radially outer side of a lower end of the upright elongate portion. This arrangement may transfer loads desirably for the L-shaped interfacing element 100C illustrated when subjected to the expected load (carried by the protruding foot member). As will be appreciated, the configuration of the interfacing elements applies an overturning moment onto the support frame (pulling the frame of the jacking devices inwardly). Consequently, it may be desirable to secure the jacking devices to the foundation 4000 in a way that resists this overturning moment. In FIGS. 11A and 11C, the slider frame 2260, which is located radially outward from the support frame 2200, is bolted to the foundation 4000. The skilled person will appreciate how the same principles can be applied for other jacking devices/arrangements, such as the bridged arrangement discussed in relation to FIG. 7.

For any jacking arrangement described herein, electronic control systems may be employed to provide precision actuation of the elevation drive unit 2280, that, together with high-torque, low-speed gearing of the motors 2282, and the finite precision inherent in the threaded rod 2292 interface with the prime carriage 2994, provide finite precision vertical movement of the interfacing element 100A. Such systems may also be communicating to drive unit 2264 of the slider frame 2260, actuators 2248 of the brace frame 2240 to coordinate precise finite movements of the translation mechanism.

The electronic control systems may be a central control system for controlling the jacking devices (e.g., the elevation and translation mechanism thereof) synchronously or otherwise in a coordinated fashion. The elevation of individual interfacing elements may be controlled in response to data or other information received or provided about load and/or alignment. The system may include sensors, such as load cells, for obtaining such data.

Returning to FIG. 7, also shown is also a second example jacking device 2200B (also referred to as a second mover mechanism), which is this case is a coupled arrangement of two jacking devices. The coupled arrangement provides a bridged arrangement, which is shown to comprise two subordinate jacking devices 2200C. The subordinate jacking devices 2200C may be similar to the first example jacking device 2200A described previously except that devices 2200C are not facing forward (i.e., in the longitudinal direction of the slider frame 2260 or toward vertical axis 2000Y) but instead face laterally relative the support frame 2220 to support an intermediate beam 2300 spanning therebetween.

The intermediate beam 2300 is shown to comprise two interfacing elements 100B. It is these interfacing elements 100B of the bridged arrangement 2200B that contact, engage and couple a section to be handled as described previously. However, in this case, rather than the prime carriages of the subordinate mover mechanisms 2200C directly supporting and vertically moving interfacing elements to handle a section of a structure, they are used to jointly support an intermediate beam 2300 and move it vertically to indirectly raise or lower the two interfacing elements 100B jointly (e.g., in unison), which themselves contact and engage the section to be handled.

The interfacing elements 100B supported on the intermediate beam may be configured to translate horizontally to vary a horizontal spacing from one another. This may be provided by horizontal slider slots 2302 of the intermediate beam 2300. An internal mechanism within the intermediate beam 2300, such as motorized rack and pinion, worm gear and threaded rod or other suitable arrangement, may be used to actuate horizontal translation of said second example interfacing elements 100B along said horizontal slider slots 2302 of the intermediate beam 2300.

The interfacing elements 100B may be mounted upon auxiliary carriages (not shown) that extend into said horizontal slider slots 2302. In the case of the free-pivoting example, the auxiliary carriages may provide the feature, i.e., structural item upon which the curved lower surface 112B of the float point 110B of these two second example interfacing elements 100B pivot upon.

Movement of the two subordinate mover mechanisms 2200C along their respective slider frames 2260C, together with horizontal translation of the two second example interfacing elements 100B, may be actioned in unison to effectively provide radial inward and outward translation of the two second example interfacing elements 100B relative the vertical axis 2000Y. This may coordinate with radial inward and outward translation of the interfacing elements 100A by the other (e.g., six) jacking devices 2200A.

It may further be appreciated that second example bridged arrangement of jacking devices 2200B, comprising said subordinate jacking devices 2200C, intermediate beam 2300 and two second example interfacing elements 100B, provides an example of how a jacking arrangement may, in addition to moving the interfacing elements of the handling assembly along the vertical axis, might also be configured to move the interfacing elements of the handling assembly about multiple horizontal translation axes.

The two subordinate jacking devices 2200C may in effect operate in the same manner as described previously with regard to freely pivoting, contacting, engaging and substantially resolving forces of a section being handled, except that rather than a section of a structure, said actions are performed to handle the intermediate beam 2300. Likewise, the parallels with the operation of the jacking devices of FIGS. 11A-C (with the second, non-gripping interfacing elements 100C) will be apparent.

In the former case, forces imparted upon the intermediate beam 2300, from the handling of a section using the second example interfacing elements 100B, are transferred to the interfacing elements of the two subordinate mover mechanisms 2200C, which themselves freely pivot upon float points upon prime carriages as previously described. Forces, moments, deflection and/or deformation of the intermediate beam 2300, during handling/lifting operations of the movement arrangement 2100 in relation to a section of a structure, may be transferred along said chain of connections to the interfacing elements of the two subordinate jacking devices 2200C, their respective support frames, brace frames, slider frames and finally, to the foundation/ground upon which the apparatus 2000 is placed.

Alternatively, arrangements may be provided to neutralise or dampen such force transfer, if and when desired. For instance, the carriages upon which the second example interfacing elements 100B of the intermediate beam 2300 are supported may be mounted relative the intermediate beam 2300 in a manner that dampens or neutralises transfer of forces to the interfacing elements of the two subordinate jacking devices 2200C.

From the foregoing discussion, it will be apparent that the interfacing elements can provide a modular and adaptable means of handling sections of a structure, in that they may be arranged in multiple ‘layers’ or tiers of connection with features of the jacking arrangement, so as to provide varying spacing, actuation, translation and movement options depending on a particular application. Additionally, by way of the modular design provided generally by the plurality of interfacing elements and corresponding plurality of jacking devices, the system 2000 can be easily assembled and disassembled at an erection site as required, at or around the desired footprint where the structure is to be placed.

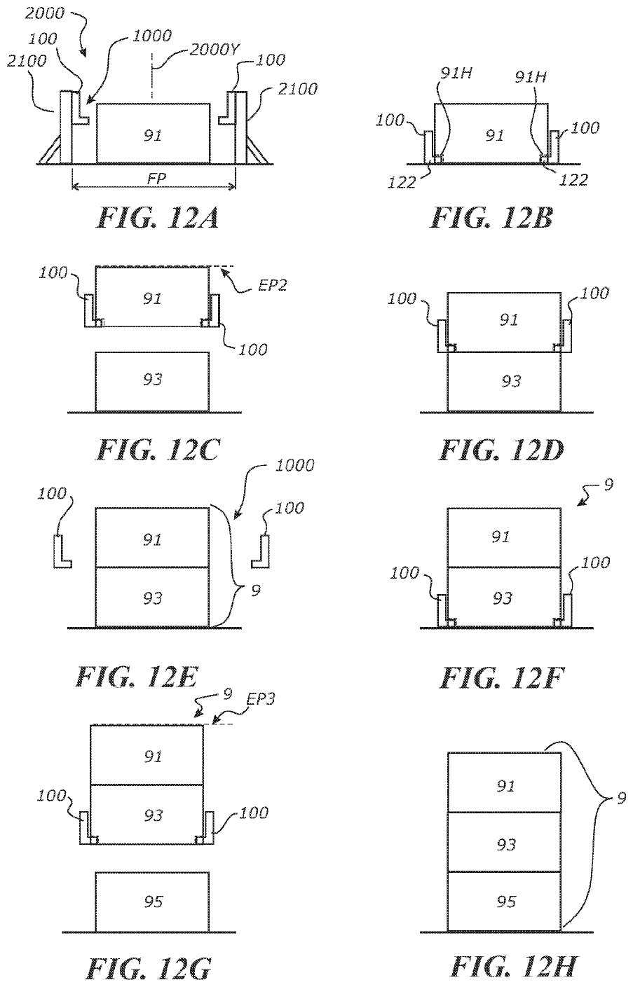

In the tower erection application of the example apparatus 2000 described so far, it may be desirable for sections of a structure to be moved to within the notional erection footprint of said apparatus 2000, e.g., within the notional circular locus defined by the interfacing elements of the handling assembly 1000, so that the sections can be combined along the vertical axis. The bridged arrangement of jacking devices, by way of elevating said intermediate beam 2300 to a raised position, provides a clearance zone 2100C through which the next section of the structure to be handled can be moved into position under the intermediate beam 2300 to within the notional erection footprint of said apparatus 2000. This is discussed in more detail below with reference to FIG. 12I. The length of the intermediate beam 2300 can be increased, and hence the distance between the subordinate jacking devices 2200C can be increased, to create a wider clearance zone for movement therethrough of larger sections of a structure.

As mentioned, the jacking arrangement 2100 is configured for moving the interfacing elements 100A of the handling assembly 1000 vertically for moving sections of the structure along the vertical axis 2000Y so as to ultimately carry out the sequential elevation of consecutive notionally numbered sections of the plurality of sections for erecting an elongate structure from the ground up. An example method of this iterative and sequential ‘bottom-up’ erection will now be described with reference to FIGS. 12A to 12H and may generally involve positioning a first (to-be-upper-most) section 91 of the plurality of sections to substantially align with said vertical axis 2000Y, i.e., within an erection footprint FP of the apparatus 2000, as shown in FIG. 12A. The footprint FP may be for example the notional surface area of circular locus 2000X of the example handling assembly 1000 of example apparatus 2000 of FIG. 7.

The jacking arrangement 2100, comprising jacking devices 2200A, 2200B, is configured to move the interfacing elements 100A, 100B of the handling assembly 1000 radially and vertically. In FIG. 12B, the jacking arrangement 2100 is actuated to cause the interfacing elements 100A, 100B of the handling assembly 1000 to move towards the first section 91 (positioned on the erection footprint FP), and to contact, engage, and couple thereto as has already been described. In FIG. 12B, the interfacing elements are engaged within section holes 91H of the first section 91 (discussed further below with reference to FIG. 12I), illustrating that the handling assembly 1000 is now coupled to said section 91. The apparatus 2000 is shown hidden in FIG. 12B for clarity of illustration.

The jacking arrangement 2100, via jacking devices 2200A, 2200B, 2200C, may then move the first section 91 up along said vertical axis from a non-elevated position to a first elevation position EP2. This is shown in FIG. 12C. Additionally, while the first section 91 is at said first elevation position (carried by the various interfacing elements 100A, 100B of the handling assembly 1000), a second section 93 of the plurality of sections may be positioned underneath the elevated first section 91.

The jacking arrangement 2100, via jacking devices 2200A, 2200B, 2200C, may then lower the first section 91 from the first elevation position EP2 toward the second section 93, to contact and align with said second section 93 so as to form a notionally combined portion 9 of the structure, such that the second section 93 now defines a lower-most section of the notionally combined portion 9. This is shown in FIG. 12D. Alternatively, or additionally, the second section 93 may be raised (e.g., via a supporting platform as discussed below) towards the first section 91.

The various interfacing elements 100A, 100B of the handling assembly 1000 may then decouple (i.e., disengage) from the first section 91 by translating radially outwardly away from the first section 91, before moving down to contact, engage and couple with the second section 93, i.e., lower the section of the notionally combined portion 9, as shown in FIGS. 12E and 12F respectively.

Thereafter, the entire combined portion 9 (in this case, first and second sections 91, 93) can be moved upwards along said vertical axis to an elevation position EP3, which may be the same or different height as the first mentioned elevation position EP2. This is shown in FIG. 12G.

While the combined portion 9 is at said elevation position EP3, the next section in the sequence, i.e., third section 95 shown in FIG. 12G, can be positioned underneath the elevated notionally combined portion 9. The jacking arrangement 2100 can then be actuated again to lower the combined portion 9 such that the lower-most section thereof (i.e., the second section 93) contacts and aligns with the third section 95. The combined portion 9 now includes the first, second and third portions 91, 93, 95, where the third section 95 defines the lower-most section of the combined portion 9, as shown in FIG. 12H.

This process may be repeated for consecutive notionally numbered sections so as to add sections in sequence to the combined portion, elevating the iteratively elongating combined portion of the structure for each section added.

Note the term “combined”, or “notionally combined”, portion may be used in relation to the sections being linked and lifted together. The portions may not be fully or completely assembled or connected, but instead temporarily coupled or interfaced for the purpose of lifting and handling operations of example apparatus and methods described herein. Complete connection of the adjacent sections may be achieved later via internal or external post-tensioning, structural stiffeners, connection elements and the like that will be apparent to the skilled person. A notionally combined portion may also have other sections added above, below, or generally to it, after the systems or methods described herein have completed their operation of erecting the structure. For these reasons, two or more sections being lifted together by apparatus and methods described herein may only present a temporary “notionally” combined portion of the structure, with complete or final erection (with or without said finishing operations described above) presenting a “finished” structure. Moreover, “elevation position” or “elevated position” when used herein in reference to the section or sections being lifted upward by the example systems and methods may be understood as a variable position, defined by a desired height from the foundation, to which the section(s) are to be elevated. The desired height may be somewhere between minimum and maximum vertical ranges of motion of the jacking arrangement 2100 parallel to the vertical axis 2000Y, or the maximum vertical range of motion of the jacking arrangement 2100 parallel to the vertical axis 2000Y. The elevation or elevated position to which a given section is raised or moved may or may not be the same as that of previous or consecutive section(s). Section(s) may vary in height as the plurality of section is iteratively added to the notionally combined portion of the structure already elevated. Hence, a height of a given section to be moved upward, a height of a previous or consecutive section moved upward, and/or maximum vertical range of motion of the jacking arrangement, may define the magnitude of said elevated position to which a given section is to be moved.

The system 2000, by way of the handling assembly 1000 and jacking arrangement 2100, provides an efficient and iterative process for ground-up erection of an elongate structure from a plurality of its pre-assembly sections by adding consecutive notionally numbered sections to an iteratively growing (elongating) combined portion. Once a desired number of sections have been added to said notionally combined portion, the ‘final’ combined portion may be lowered by the jacking arrangement 2100 onto a foundation before decoupling the interfacing elements 110A, 110B of the handling assembly 1000 for a final time.

Between FIGS. 12B and 12C (and equivalently, between FIGS. 12F and 12G), it may be necessary to position the second section 93 within the erection footprint FP beneath the elevated first section 91. For a jacking arrangement that substantially surrounds the erection footprint FP, such as that illustrated in FIG. 7, one or more jacking devices may have to be temporarily moved or disassembled to allow additional clearance for operations by crew or machinery on the erection site. Alternatively, the present disclosure provides for carrying this out by passing the second section through a clearance zone beneath the bridged jacking arrangement, as discussed previously. FIG. 12I illustrates an example of this process for the handling system 2000, in which a section 92 is at an elevation position EP1. The section 92 is shown as a single circular tower section for clarity but may in fact represent a lower-most section of a notionally combined portion having various tower sections already stacked above it.

The intermediate beam 2300 of the bridged jacking arrangement 2200B is elevated, as well as all interfacing elements 100A, 100B supported on it, to define a clearance zone 2100C below the intermediate beam 2300 and between the subordinate jacking devices 2200C. The next notionally numbered section 94 is shown positioned adjacent the system 2000 to be moved underneath elevated section 92 for addition to the elevated section 92. As represented by arrow A10, the section 94 is directed through clearance zone 2100C, underneath intermediate beam 2300, onto the erection footprint of the apparatus 2000. The elevated section 92 can now be lowered atop the section 94 for contact and alignment therewith.

FIG. 12I also shows in more detail an example of the type of sections that can be handled and assembled by the system. In this example, the sections are concrete rings (i.e., circular sections of a hollow cylinder) having a number of pocket-like holes 92H distributed around their lower surfaces. The holes 92H are configured to receive the foot members of the interfacing elements and the number of interfacing elements in an assembly may correspond to the number of section holes 92H. The holes 92H are one exemplary means which can be pre-formed, pre-cast or pre-assembled as part of a section of a structure to engage with the foot members (pedestals 122) of lower engaging portions 120 of the example interfacing elements 100 previously described.

In some examples, the sections of the elongate structure may be pre-cast concrete sections that have been previously match-cast against one another, so as to present upper and lower faces that conform closely or exactly with those of sections to be placed directly above and below. Alternatively, the sections may be pre-assembled or pre-formed metal sections. In either case, correct and proper alignment of the two sections 92, 94 is preferable prior to elevation of the two sections 92, 94 and addition of the next section(s).

While the handling assembly and jacking arrangement examples described could be used for minor horizontal adjustments of the elevated section 92 (and/or notionally combined portion) to align with the lower section as the two are brought into contact, some applications may benefit from limiting or completely preventing horizontal movement of the elevated section 92 (and/or notionally combined portion) during this stacking operation due to load considerations.

As such, the lower section is preferably displaceable or movable in some manner horizontally, so that alignment features of the two sections can help move and guide the lower section 94 into alignment with the upper section 92 as the two are brought together (either by lowering the upper section 92 or raising the lower section 94, or both).

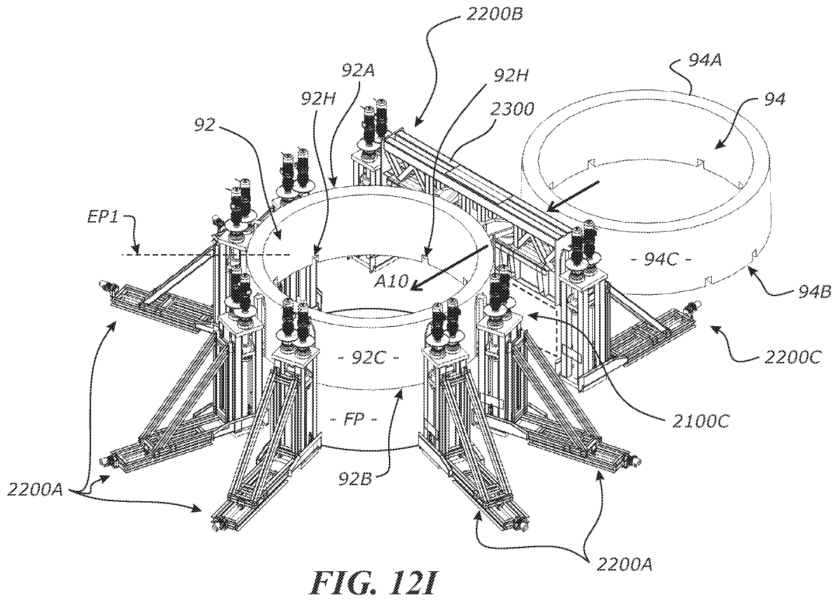

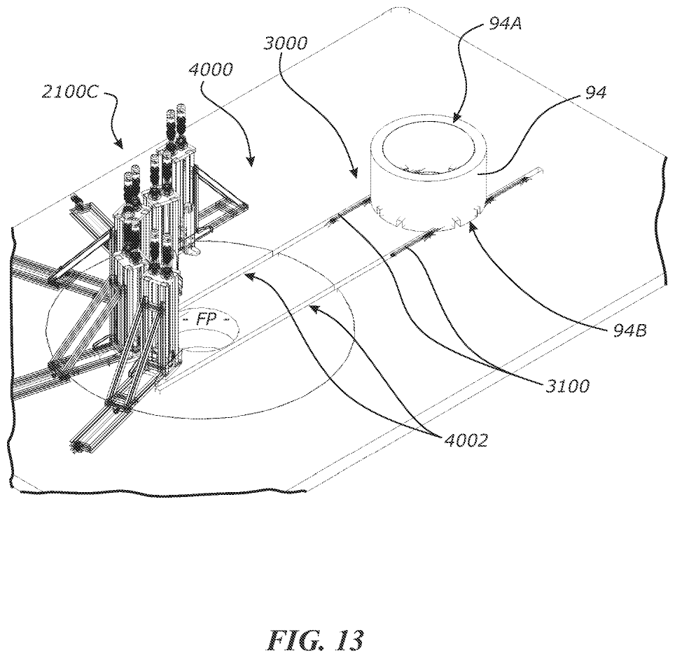

FIG. 13 shows an example system 2001 on a foundation 4000, which includes an example alignment platform 3000 (also referred to as a displacement platform) for supporting a lower section of the tower, wherein the alignment platform 3000 is moveable in a horizontal plane to enable alignment of the lower section with the one or more upper sections. Part of the example system 2001 is omitted for clarity (i.e., a number of interfacing elements and jacking devices are hidden from view). Preferably, the jacking arrangement is substantially the same as that of FIG. 7 or 11A.

The alignment platform 3000 is provided for aligning two sections of a structure being erected, wherein a first lower section 94 of the two sections is supported by the alignment platform 3000 to be brought into contact with a second upper section of the two sections (not shown, but may for example be considered as elevated section 92 of FIG. 12I), such as by lowering the upper section onto the lower section 94.

The alignment platform 3000 is shown in FIG. 13 as comprising a pair of elongate support arms 3100 arranged to travel horizontally along rails or tracks for delivering the lower section 94 to the jacking arrangement (i.e., the footprint). The tracks may be recessed slots 4002 of the foundation 4000 in which the support arms are housed, or rails that sit on top of the foundation 4000, that permit the support arms to travel in one dimension.

FIG. 14 shows the example alignment platform 3000 in isolation. Generally, the alignment platform comprises at least one support arm 3100, but preferably two as shown. Each support arm 3100 is an elongate beam-like structure coupled to a plurality of carriages 3110 (referred to as arm carriages) which are disposed along the length of the arm. In FIG. 14, each arm 3100 comprises four carriages, one disposed at either end and two therebetween. Generally, the support arms 3100 comprise at least one carriage 3110 (the number selected according to, for example, load and the length of the arm). The support arm 3100 may have a flat upper surface for mounting (directly or indirectly) a lower surface of the section being handled.

The alignment platform 3000 may also comprise a cross-member 3112 (e.g., planar circular, or beam-like) spanning between the support arms 3100 to spread the load, if desired. The alignment platform 3000 may comprise a multi-part cross-member beam 3112 having an engaging feature 3113 at either end for engaging a cooperating feature attached to (or formed within) a section.

The support arm 3100 is moveably coupled to the carriages in a way that enables the arm to move relative to the carriages in the horizontal plane. Such movement is preferably ‘reactive’ in the sense that the arm 3100 is configured to move under the influence of an external force, without actuation. Preferably, the support arm has at least two degrees of freedom, including translational and/or rotational degrees of freedom. The support arm may be able to move freely in the horizontal plane.

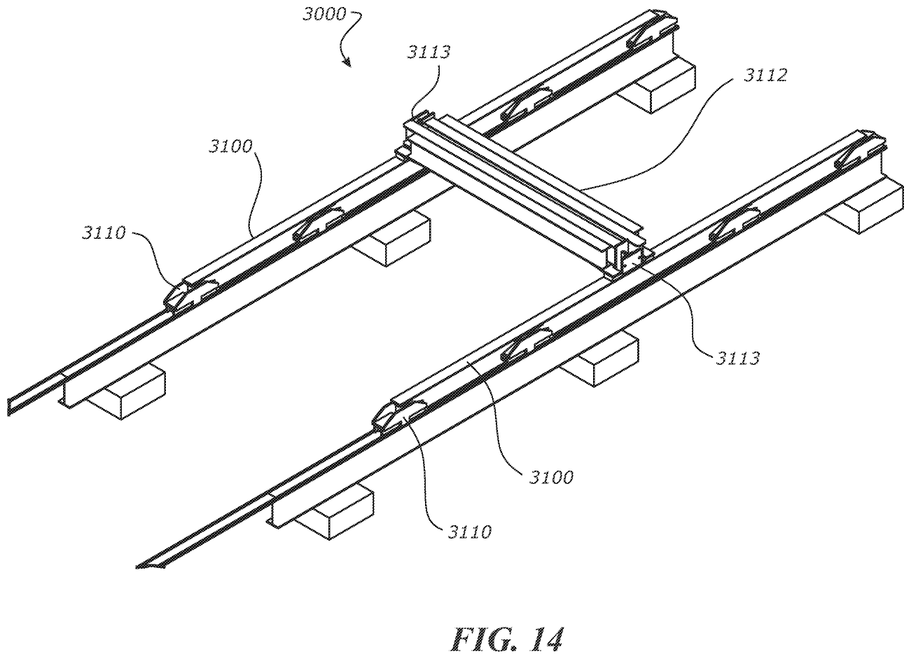

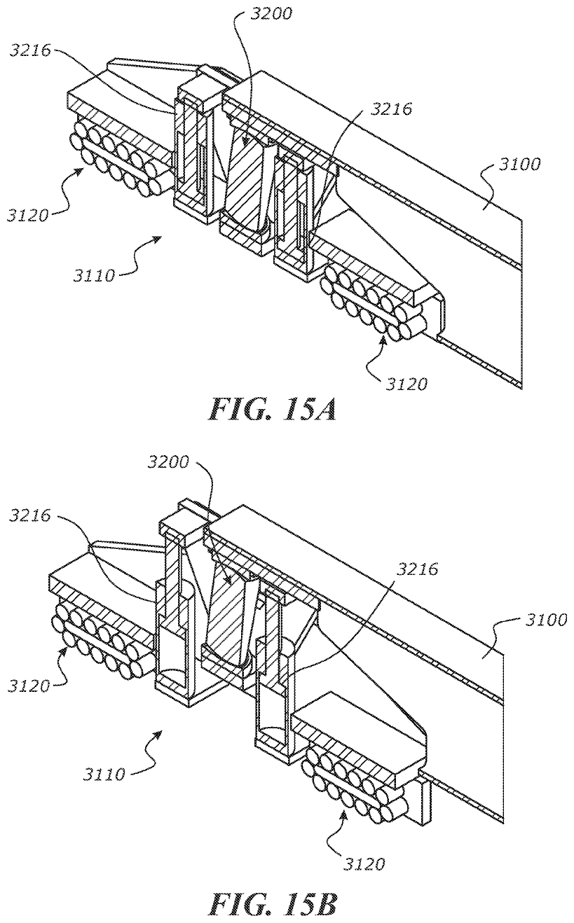

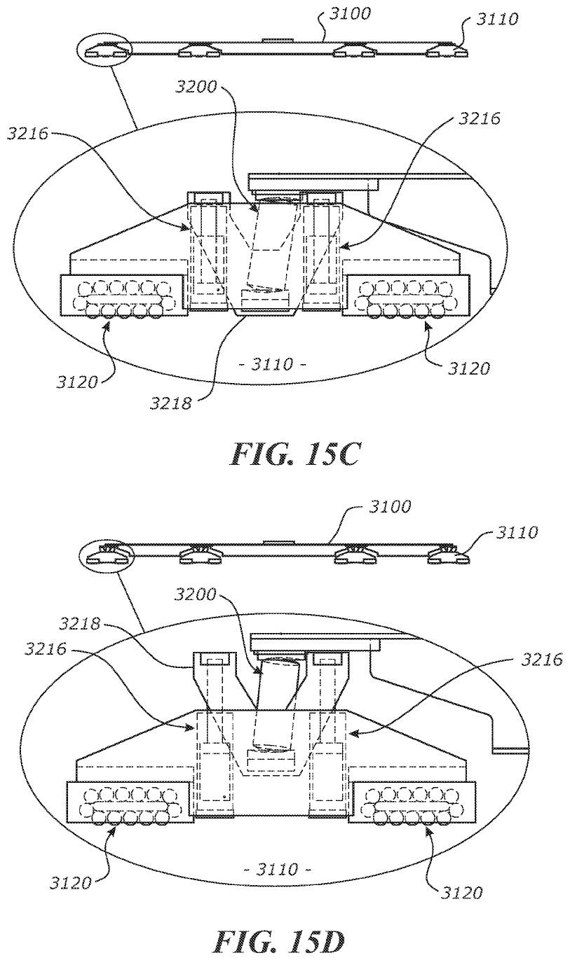

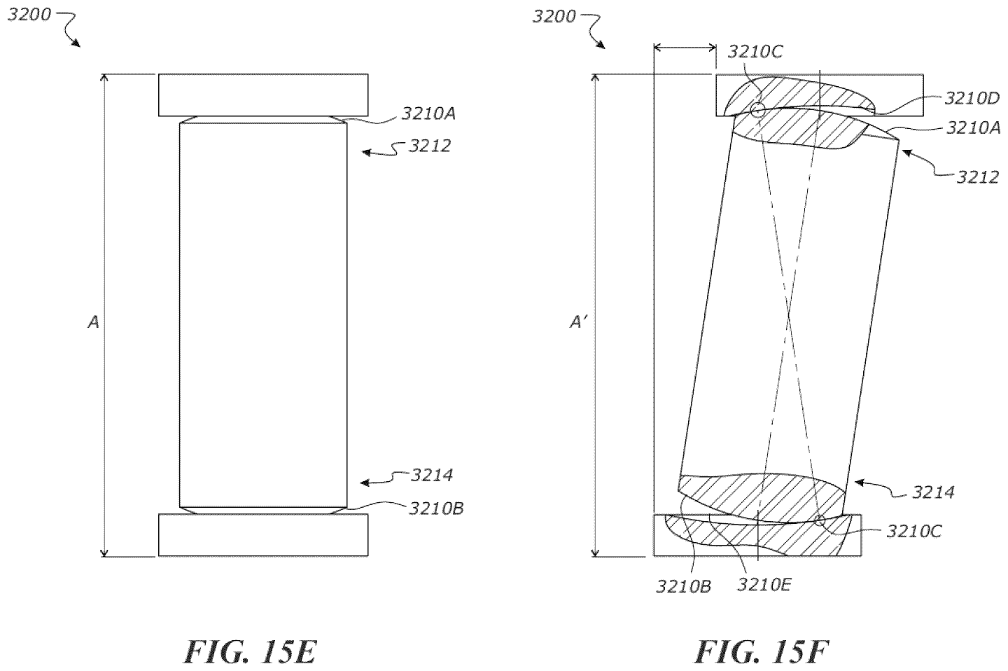

One example of a coupling mechanism between a carriage and a support arm that permits the relative movement described above is shown in FIGS. 15A-D in the form of a displacement prop 3200 provided within each carriage 3110. FIGS. 15A-D show cross-section views through a carriage 3110 at an end of the support arm 3100. The displacement prop 3200 is shown in isolation in FIGS. 15E-F.

At least part of the displacement prop 3200 is configured to displace freely along at least one substantially horizontal translation axis so as to permit a free displacement of the at least support arm 3100 and thus lower section 94 relative the foundation 4000. The free displacement of the at least one support arm 3100 and thus lower section 94 relative the foundation 4000 enables alignment features of the two sections 92, 94, once interfacing, to inform displacement of the lower most section 94 along said at least one substantially horizontal translation axis so as to move and guide the lower section 94 into alignment with the upper section.

The example displacement prop 3210 has an upper end 3212 and lower end 3214. The upper end and lower end 3212, 3214 may each comprise respective spherical ball-joint interfaces 3210A, 3210B, being convex outwardly protruding surfaces of the displacement prop at both ends 3212, 3214 for engaging into concave rolling surfaces 3210D, 3210E. A contact point 3210C between those surfaces when the prop is in a displaced position can be seen in the cross-sectioned portion of FIG. 15F. As illustrated in FIGS. 15E-F, the displacement prop length A is shortest when the displacement prop is substantially vertical (being a longer length A′ in FIG. 15F). As such, the displacement prop can be biased toward the vertical position, which can provide a self-centering function. This is one example for achieving the desired function and other suitable means will be apparent to the skilled person.

The upper end 3212 of the displacement prop 3200 may be configured to allow the support arm 3100 to displace both translationally (in the horizontal plane) and angularly (rotationally), with multiple degrees of freedom. Likewise, the lower end 3214 may be configured to allow the prop 3210 itself to displace both translationally (in the horizontal plane) and angularly (rotationally), with multiple degrees of freedom. The angular freedom allows the supported section to rotate in-plane, while the translational freedom allows the supported section to shift in-plane.

In this example configuration, the displacement prop 3210 can displace freely along a plurality of substantially horizontal translation axes to permit a free displacement of the at least support arm and thus lower section relative the foundation. The extent to which the support arm 3100 can freely displace about upper end 3212 of the displacement prop 3200, may depend on the configuration of the respective spherical ball-joint interface 3210A. Likewise, the extent to which the prop 3210 can freely displace about its lower end 3214, may depend on the configuration of the respective spherical ball-joint interface 3210B. For instance, a curvature radius of the convex surface of each spherical ball-joint interface relative the concave surface, and vice versa, may define or inform the ranges of motion afforded by a given spherical ball-joint interface 3210A, 3210B.

Other mechanisms or joint connections may be employed in lieu of the example spherical ball-joint interface(s), such as hinged or ball-joint bearing connections, knuckle pin-type connections, or any other suitable engineering interface that permits some range of horizontal displacement between the support arm relative the foundation, via the displacement prop.

Hard limits to the range of motion of the displacement platform and its support arm(s) relative the static foundation may be provided by the physical structures and componentry surrounding the displacement prop(s), together with the configuration of the support arm(s), support arm carriage(s) and/or the displacement prop(s).

Returning to FIGS. 15A-D, the illustrated carriages comprise a pair of roller assemblies 3120, longitudinally flanking the displacement prop 3210 and sandwiched between the flanges of the arm carriage 3110. These roller assemblies 3120 are provided purely as exemplary means by which the support arm(s) 3100 may translate horizontally along the rails or tracks (e.g., slots 4002 of the foundation 4000) and other suitable means will be apparent to the skilled person. The roller assemblies of the carriages may be driven (e.g., by a motor) to move said support arm(s) 3100 and/or the support arms. Alternatively, the roller assemblies 3120 may simply provide ‘passive’ rolling surfaces and the movement of the support arms may be driven externally. In one preferred example, the system comprises a winch system (not shown) connected to the alignment platform for pulling the alignment platform into position.

The rails or tracks (e.g., slots 4002) and the roller assemblies 3120, are provided as a convenient way of delivering the next section to within the notional erection footprint FP for handling/lifting by the system 2000 (preferably through the clearance zone 2100C of the bridged arrangement). This need not be connected to the displacement platform 3000 as described. Instead, the sections may be provided by another separate mechanism, such as a conveyer track, or other moving platform, with the displacement platform already provide at a fixed location within the erection footprint FP of the system 2000. However, in a preferred example the displacement platform 3000 can serve a dual-purpose of aligning lower section 94 to upper section 92, as well as for delivering said lower section 94 into position within the erection footprint FP.

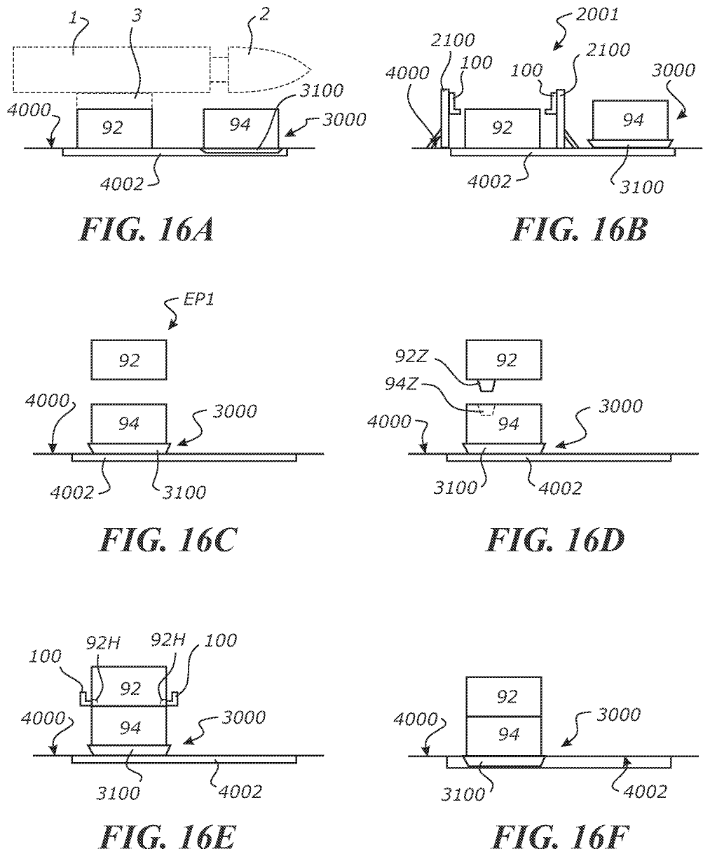

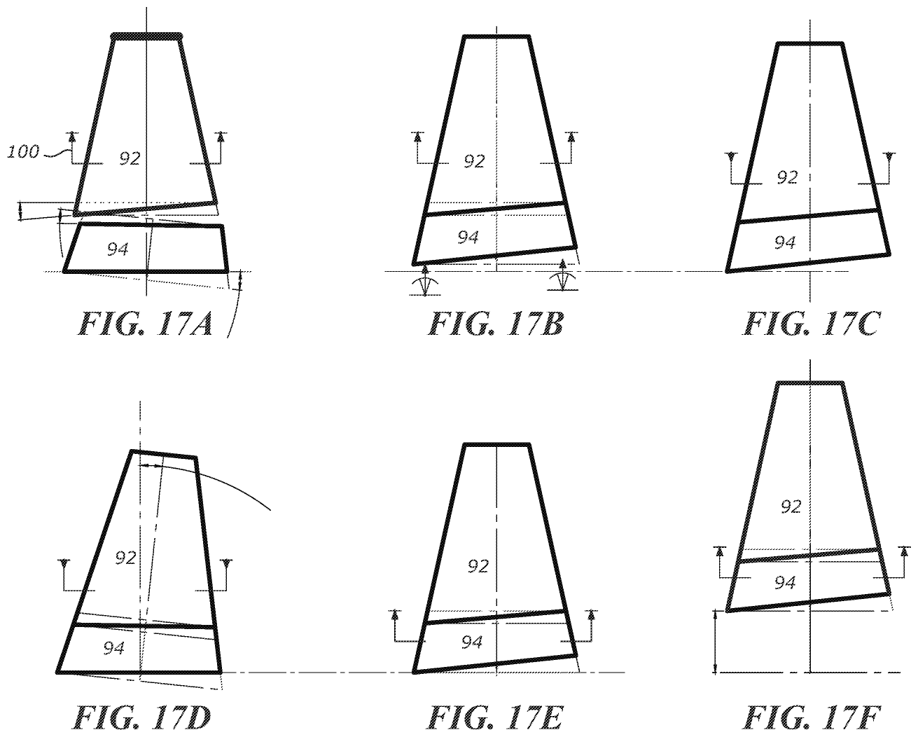

Preferably, the alignment platform 3000 is also configured for raising and lowering the support section, such as by raising and lowering the support arms at the carriages via one or more elevation mechanisms. FIGS. 15B and 15D show an elevated position, with one example elevation mechanism in the form of hydraulic cylinders 3216 internal to (housed within) the carriages (shown in an extended position in FIGS. 15B and 15D). In other examples, the displacement props 3210 may be configured to carry out the vertical movement, such as via hydraulic cylinders internal to (housed within) the displacement props 3210. The hydraulic cylinders move the support arm(s) 3100 vertically as shown. The hydraulic cylinders are shown either side of the displacement prop and may be coupled to the displacement prop via V-shaped support plates 3218 (one either side) as shown in FIGS. 15C and 15D. In some examples, the raising of the support arms causes the support arms to protrude from the slots 4002, while the lowering of the support arms causes the support arms to recess into the slots 4002, such that the alignment platform can be used to transfer the load of the supported section to and from the foundation. Preferably, each arm comprises at least two carriages each having an elevation mechanism (e.g., a pair of hydraulic cylinders coupled to the displacement prop via a support member) such that the supported section can be raised level (i.e., by actuating the elevation mechanisms in unison) or tilted (i.e., by actuating the elevation mechanisms differently). The ability to tilt the alignment platform and hence the section supported on it provides a further degree of freedom that can be used for aligning the supported (lower) section with the section above. This aspect of the alignment is discussed below with reference to FIGS. 16 and 17.

The elevation mechanism may comprise a valve and pump arrangement, which can pressurise the hydraulic arrangement of the displacement platform 3000 to lift it up, and release to vent said hydraulic pressure to lower said displacement platform 3000. The lowering of the displacement platform 3000 may be manually actioned via activated release of said valve, or may simply be an automatic/passive action caused once a sufficient weight or load bearing is imparted on said displacement platform 3000, i.e., as/when the upper section 92 and aligned lower section 94 are lowered together.

An example method of aligning two sections of a structure is shown in FIGS. 16A to 16F and will now be described in relation the example alignment platform 3000 of FIGS. 13 to 15. This example uses recessed slots 4002, but the same principles can apply for other configurations.

In FIG. 16A, a cross-sectional schematic view of a foundation 4000, slots 4002 thereof, support arm 3100 and alignment platform 3000 are shown. Also shown is first lower section 94 above alignment platform 3000, which in this example is recessed into slots 4002 such that the load is carried partly or wholly by the foundation 4000.

The second (upper) section 92 has been placed generally at the erection site, and may already be connected to nacelle 1, rotor hub 2 and a transition section 3 of the wind turbine installation (hence section 92 being already a notionally combined portion of the structure). It is referred to as upper section for the sake of consistency, but is of yet to be elevated to an upper position in the step of FIG. 16A.

The method may generally comprise placing the first lower section 94 on the alignment platform 3000, such that the section 94 is supported (partly or wholly) on the platform 3000 (e.g., on the support arms and/or cross-bar member), or on the foundation above the platform 3000.

The displacement platform 3000, in particular the support arms 3100, may be elevated to protrude out from the slots 4002, e.g., using the hydraulic cylinders mentioned above, to transfer the load of the section 94 completely onto the platform 3000. This is shown in FIG. 16B, which also shows the example apparatus 2001 having been arranged around the second upper section 92.

In FIG. 16C, the second upper section 92 is elevated as described previously.

The lower section 94 is then carried into position beneath the second section 92, i.e., moved into notional erection footprint FP, via horizontal travel of the alignment platform 3000 (e.g., pulled on the roller assemblies 3120 of the carriages using the winch) along the slots 4002, as discussed previously.

Once the lower section 94 is in general alignment with the upper section 92, and while still supported on the alignment platform 3000, the method may proceed FIG. 16D in which the second upper section 92 is lowered onto the first lower section 94 such that alignment features at a lower end thereof become proximate corresponding alignment features at an upper end of the first lower section 94. In other examples, the two sections are brought towards one another by also, or alternatively, raising the lower section 94 using the elevation mechanism of the alignment platform.

In the illustrated example, the alignment features are represented by a male tapering pin (e.g., cone) 92Z protruding downwardly from a lower end or surface of the second upper section 92, and a corresponding female tapering (e.g., cone-shaped) hole 94Z in the upper end or surface of the first lower section 94. These alignment features 92Z, 94Z are merely illustrative examples. Alignment features may take a variety of forms, such as male to female mating pin-hole interfaces, internal or external walls, and others that will be apparent to the skilled person. Preferably, the features are tapered or otherwise configured such that as the sections are brought into closer proximity, the alignment features naturally self-guide into engagement with one another to bring the sections into precise alignment. The alignment platform adjusts by displacing and/or rotating according to the various degrees of freedom in response to the guiding engagement of the alignment features as already described, thus aligning the lower section with the position and rotation of the upper section. In other words, the alignment features inform and affect horizontal displacement and/or rotation (about the vertical axis) of the first lower section 94 owing to the ability of the alignment platform to move freely in the horizontal plane (or along at least one horizontal translation axis).

When the alignment features are fully engaged, the two sections may also be in complete engagement and alignment, thereby forming and/or adding to the notionally combined portion of the structure as previously described. This is shown in FIG. 16E.

The interfacing elements of the handling assembly of example apparatus 2001 may still be coupled to (e.g., engaged) with the upper section and thereby supporting at least some of the weight of the upper section 92 during the alignment process, as shown by interfacing elements 100 in FIG. 16E.

The example handling assembly and jacking arrangement described herein may be generally configured to support the load of a given section, as well as a given notionally combined portion of the structure to enable successive elevation of the iteratively growing combined portion. By contrast, the displacement platform 3000 may only need to support the weight of one section.

Once both sections are in substantially complete alignment, the displacement platform 3000 may be actuated to vertically lower in unison with corresponding vertical lowering of the jacking arrangement of the example apparatus 2001, so that both the upper section 92 and aligned lower section 94 are lowered onto the foundation 4000. This is shown in FIG. 16F.

The load of the upper section 92 resting atop the lower section 94, once both are on the foundation (i.e., once the apparatus 2000 is no longer supporting said weight/load of the section 92), may impart a flush/contiguous coupling together of the two sections, at least at their respective ends.

Following the alignment method, the erection method described above in relation to example apparatus 2000 may continue, whereby the jacking arrangement 2100 actuates to move interfacing elements radially outwardly from the upper section 92 and then downwardly to engage and lift the now aligned lower section 94, and hence the notionally combined portion of the structure now includes lower section 94.

The next consecutive notionally numbered section to be added can then be loaded onto the displacement platform 3000 (which has since translated along slots 4002 back to a position outside the apparatus 2001), and the above process repeated for alignment of the next consecutive notionally numbered section with the notionally combined portion of the structure (now including lower section 94).

FIGS. 17A-F illustrate a further alignment method, which may be used when the lower surface of one or more sections is not level relative to the vertical axis of the structure (e.g., due to match-cast error during the fabrication of the sections). The additional steps, which will be apparent from the following discussion, may supplement or replace steps in FIGS. 16D-F as will be apparent.

In FIG. 17A, a notionally combined portion 92 of the tower is elevated via interfacing elements of a jacking arrangement (any of those previously described) and a subsequent (lower) section 94 is positioned below ready for combination. Although not shown, the lower section 94 is positioned on the alignment platform previously described. As illustrated, the lower surface of the lower section of the combined portion 92 is out of level with respect to the foundation (and relative to the vertical axis of the structure). Additionally, or alternatively, the top surface of the lower section 94 may be out of level.

In FIG. 17B, the two portions (i.e., the notionally combined portion 92 and the lower section 94) may be brought towards one another as described in FIGS. 16D-E. However, in this example, the lower portion is tilted such that the adjacent surfaces of the two engaging sections are parallel. In particular, the alignment platform is lifted (e.g., via independent hydraulic cylinders within the carriages) asymmetrically such that the lower section 94 is skewed in conformity with the lower surface of the combined portion 92. In the illustrated example, the right side of the lower section is lifted to a greater height than the left side via respective lifting mechanisms within the alignment platform. The sections may be guided into general alignment and engagement as previously described.

In FIG. 17C-D, the sections 92 and 94 are lowered together until at least part of the tower (the left side in the illustrated example) contacts the foundation 4000. The load may be transferred to the foundation via controlled adjustment of the jacking arrangement and/or alignment platform to prevent damage to the structure. The hydraulic jacks in the alignment platform may be compressed under the load of the tower and the resulting pressure may be relieved via hydraulic relief valves allowing the structure to rest on the foundation. As shown in FIG. 17D, the structure may rest in a tilted position, in which the vertical axis of the structure is out of line with the ‘true’ centre line (being the desired vertical axis of the complete elongate structure).

In FIG. 17E, the interfacing elements of the jacking arrangement are repositioned to engage the new (lower) section and used to lift the combined structure in such a way that the structure rotates back into alignment with the ‘true’ centre line. The jacking arrangement may be controlled via a program executed by a central controller for adjusting the angle of the tower.

In FIG. 17F, the interfacing elements are lifted (via the jacking arrangement) to elevate the newly combined portion for addition of a further section. During this operation, the jacking arrangement may be controlled synchronously.

It will be appreciated that aspects of the example methods described in relation to FIGS. 12A to 12H may also apply to or overlap with the example method described in relation to FIGS. 16A to 16F, where the alignment procedures of the example method described in relation to FIGS. 16A to 16F being an optional sub-set of, or separate from, the broader erection method described in relation to FIGS. 12A to 12H. Likewise, the alignment procedure of FIGS. 17A-F may be an optional sub-set of, or separate from, the broader alignment method and/or erection method described in relation to FIGS. 16A-F and FIGS. 12A-H, respectively.

It will also be appreciated that the methods of alignment, as well as the example displacement platform 3000 described in relation to FIGS. 13 to 15, may be employed generally where a method of aligning two sections of a structure being erected is desired or required, wherein a second upper section of the two sections is to be lowered atop said lower section for contact and alignment with said lower section. The alignment platform, and/or method of aligning, may also be employed off-site to align sections together for later transport to an erection site.

As mentioned, the above methods and systems are preferably employed for erecting a wind turbine tower, which may be assembled from a large number of sections, such as the concrete rings illustrated in FIG. 12I. Whilst the drawings have so far illustrated the combination of one or two sections for ease of illustration, it has been noted that the upper section at any given stage could itself be a combination of previously assembled sections.

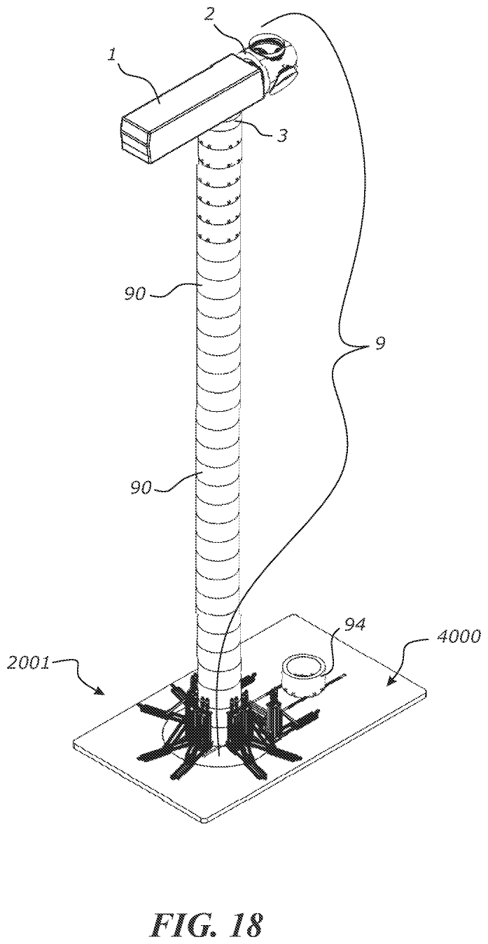

With this in mind, FIG. 18 illustrates a later stage in the assembly process of a wind tower using example system 2001 on a foundation 4000. The system 2001 may have performed multiple iterations of the erection method in FIGS. 12A-H (preferably including the alignment methods of FIGS. 16A-F and/or FIGS. 17A-F). Here, the system 2001 is about to lift a notionally combined portion 9 of a wind tower comprising a stacked assembly of sections. The next section to be added—section 94—awaits adjacent the system 2001 similarly to section 94 in FIG. 12I. FIG. 18 illustrates visually the form-factor and lifting capacity of a given example system employing the handling systems relative the structure being erected.

In FIG. 18, the first (upper-most) section of the plurality of sections to be iteratively erected comprises the nacelle 1 and rotor hub 2 of the wind turbine, as shown. The nacelle may be already coupled and connected to the upper-most tower section of the wind turbine tower, such as via a transition section 3.

The subsequent consecutive notionally numbered sections may be similar ring sections of the wind tower. Generally, the sections may be circular or polygonal steel or concrete rings separately pre-cast, pre-formed or preassembled and transported as a plurality of sections to the erection site where each consecutive notionally numbered section is connected to its preceding section at the lower end of the notionally combined portion. With each addition, the upper-most section of the wind turbine installation (in this case, the combination of the nacelle, rotor hub and upper-most tower section) is iteratively elevated.

In other applications, multiple portions of a structure may be iteratively erected by the system and then transported, or together combined, external the apparatus and method described above.

In FIG. 18, the sections of the wind tower are of constant diameter such that the wind tower is non-tapering (i.e., constant cross-section). However, in other examples, each consecutive notionally numbered tower section may, such as in the case of an upwardly tapering tower of a wind turbine installation, comprise a larger diameter than the previous notionally numbered tower section. As such, the interfacing elements of the handling assembly of a given system may benefit from radially inward and/or outward adjustment, such as for example by way of the slider frame 2260A, 2260C and horizontal slider slots 2302 of example jacking arrangement 2100 of example system 2000, as already discussed. Additionally, the bridged jacking arrangement 2200B of example system 2000 can also be configured for providing an appropriately sized clearance zone 2100C underneath which consecutive notionally numbered tower sections can move to enter the notional erection footprint of the apparatus 2000. Hence, this can enable larger diameter tower sections to enter the notional erection footprint of the apparatus 2000, and then be handled, elevated and assembled by the apparatus 2000.

In general, sections of a structure as referred to herein, may relate to sections (of various forms, configurations and shapes) of structures of substantial magnitude, i.e., civil engineering structures or installations, though examples may more specifically relate to sections such as rings, columns or towers for wind turbine installations and the like. Such sections may be pre-cast concrete segments (rings), metal or other assembled segments of the tower to be iteratively erected or assembled together. The sections may be connected to or include the nacelle of the tower, or other components thereof, such as the internals (gear box, motor, slew ring, etc.) of the nacelle, parts of the foundation, and the like, or where any large, cumbersome, heavy and/or unwieldy section of a wind turbine installation is desired to be handled or moved.

These examples and their given application to wind turbine installations are provided to illustrate the economies of scale, form factor, efficiency and other advantages as described herein, resulting from the features of the disclosure when applied to that application. However, it will be appreciated that the disclosure may be applied to a number of applications where any large, cumbersome, heavy and/or unwieldy sections of a structure of a substantial magnitude, are to be handled, and in particular moved, so as to facilitate erection, assembly and/or construction of at least part of said structure.

Other example structures could include towers of buildings in general, support columns of parts of a commercial building, or for bridges, piers, marine installations, etc. Indeed, those skilled in the art may envisage several other applications which could benefit from employment of the present disclosure to facilitate handling, i.e., movement of sections of a structure for erection, assembly and/or construction thereof. Moreover, those skilled in the art may envisage several applications which could benefit from employment of the present disclosure to facilitate handling, e.g., movement, of sections in and of themselves (not necessarily as part of an erection, assembly and/or construction process of the associated structure), such as handling, i.e., movement, of sections for the purpose of transporting, storing, unloading, etc., said sections from one destination to another. For instance, the handling system could be applied to a stationary application, i.e., to move or handle sections of a structure about one axes of translation or rotation, or to a mobile application, i.e., a large vehicle or other movable platform (conveyer of an assembly area) to move or handle sections of a structure about one or a plurality of axes of translation or rotation corresponding to the axes of translation or rotation of the platform or vehicle.

Example ranges of size and tonnage sections for a circular tower of a wind turbine installation will now be given to illustrate the capabilities of handling assemblies and apparatuses described herein, where said tower may comprise or be erected from a plurality of pre-cast concrete circular tower sections. These ranges are provided for exemplary illustration of the capability of the present disclosure but are not intended to limit that capability.

A given section of a plurality of sections may be about 1 m to about 2 m, preferably, 2.4 m in height.

A given section of a plurality of sections may have a diameter of about 4.5 m, 4.58 m, 4.68 m, 4.78 m, 4.89 m, 4.92 m, 5.10 m, 5.2 m, 5.3 m, 5.41 m, 5.51 m, 5.61 m, 5.72 m, 5.82 m, 5.93 m, 6.03 m, 6.13 m, 6.24 m, 6.34 m, 6.44 m, 6.55 m, 6.65 m, 6.76 m, 6.86 m, 6.92 m, 7.07 m, 7.17 m, 7.28 m, 7.38 m, 7.48 m, 7.59 m, 7.69 m, 7.79 m, 7.89 m and/or 8 m.

Each of the above described sections may have a mass of about 1,000 kgs, 1,100 kgs, 1,200 kgs, 1,300 kgs, 1,500 kgs, or anywhere between about 1,000 kgs to 2,000 kgs.

A given tower of a wind turbine installation to be erected may comprise a plurality of sections.

Said tower may define an elongate structure to be erected by the system and/or methods described herein, and comprise a plurality of sections to be handled or moved by the handling assembly and/or system described herein.

Said elongate structure or tower may comprise an upper non-tapered portion of 32 sections and a lower tapered portion of 36 sections for a total 68 sections of the plurality of sections.

The 32 sections of the upper non-tapered portion of the elongate structure or tower may be about 2.4 m in height and have a diameter of about 4.5 m, and a mass of around 1,000 kgs to 1,500 kgs each.

The 36 sections of the lower tapered portion of the elongate structure or tower may be each about 2.4 m in height and having a diameter ranging from about 4.5 m to about 8 m, varied between one another by about 0.10 m increments (i.e., a diameter of about 4.58 m, 4.68 m, 4.78 m, 4.89 m, 4.92 m, 5.10 m, 5.2 m, 5.3 m, 5.41 m, 5.51 m, 5.61 m, 5.72 m, 5.82 m, 5.93 m, 6.03 m, 6.13 m, 6.24 m, 6.34 m, 6.44 m, 6.55 m, 6.65 m, 6.76 m, 6.86 m, 6.92 m, 7.07 m, 7.17 m, 7.28 m, 7.38 m, 7.48 m, 7.59 m, 7.69 m, 7.79 m, 7.89 m or 8 m).

A total height of the elongate structure or tower above the foundation thereof may be about 160 m.

A height above a foundation to the top of the upper non-tapered portion of the elongate structure or tower may be about 60 m, constituting the upper-most 60 m of the total height of the elongate structure or tower.

A diameter of the upper non-tapered portion of the elongate structure or tower may be a constant 4.5 m.

A height above a foundation of the lower tapered portion of the elongate structure or tower may be about 100 m, constituting the lower 100 m of the total height of the elongate structure or tower.

A diameter of the lower tapered portion of the elongate structure or tower may range from about 4.5 m at its height to about 8 m at the foundation.

A nacelle of the wind turbine installation that may be lifted by apparatus and/or methods described herein as part of a notionally combined portion of the structure, may have a mass of about 1,000 kgs.

A total mass of the wind turbine installation, including the nacelle, rotor hub, and tower structure, may be about 3,917,614 kgs, or between about 3,000,000 kgs to 4,000,000 kgs.

Hence, a total basic, static and/or dynamic lifting capacity of an example system for erecting said wind turbine installation may be about 4,920,000 kgs, or between about 3,000,000 kgs to about 5,000,000 kgs.

The example apparatus 2000 described herein is shown to have eight interfacing elements 100A, 100B driven by two elevation mechanisms 2290 and elevation drive units 2280 each, where a total basic, static and/or dynamic lifting capacity of the example apparatus, i.e., of the movement arrangement 2100 thereof, may be about 4,920,000 kgs.

The elevation drive unit 2280 DC or AC motors 2282 may comprise of 15 KW DC motors, coupled to appropriate gearbox arrangements that step down the motor speed of about 1,450 revolutions per minute to an output speed of about 16 revolutions per minute.

A height of the interfacing element 100A, 100B, the coupling member thereof, and/or a distance between the upper and lower engaging portions, may be about 1.8 m, or between about 1 m to 2 m or 3 m.

A width of the interfacing element 100A, 100B and/or the coupling member thereof may be about 0.55 m, or between about 0.5 m to about 1 m.

A notional diameter of the circular locus of a handling assembly and/or of the notional erection footprint of example system may be between about 2 m to about 8 m or 10 m.

A handling assembly may be configured such that a notional diameter of its circular locus may be adjusted to be between about 2 m to about 10 m.

A system and/or its jacking arrangement may be configured such that a notional diameter of its notional erection footprint may be adjusted to be between about 2 m to about 10 m.

An example system and its jacking arrangement may be configured to withstand a wind load acting on an up-held elevated portion of a structure of about 550 kN.

Said wind load may be for example caused by winds of up to 30 m/s acting on, for example, a 160 m tall portion of elongate structure being up-held or elevated by the system and its jacking arrangement.

Each pair of elevation drive unit and elevation mechanism, for each interfacing element, may hence provide a total basic, static and/or dynamic lifting capacity of about 307,000 kgs each.

The threaded rod 2292 and prime carriage 2994 interface, may comprise for example SKF planetary roller screw HRP/HRC/HRF180.

A dynamic load rating (L10 life as understood by those skilled in the art) of an example jacking arrangement of an example system for erection of said example said wind turbine installation may be such that 90% of a sufficiently large sample of such threaded rod 2292 and prime carriage 2994 interface(s), (for example, each being roller screw), can be expected to attain or exceed 1,000,000 revolutions under a constant centrally acting pure axial load without fatigue or flaking.

A mass of the intermediate beam 2300 of the example apparatus 2000 may be about 13,921 kgs, or between about 10,000 kgs to about 15,000 kgs.

A total height of an example system 2000 may be about 6.5 m, or between about 4 m to 8 m, depending on the application (i.e., height of sections to be handled and lifted).

An elevation cycle time of an example system 2000 may be about 3 sections per hour, i.e., 3 sections per hour may be elevated to add to a notionally combined portion.

An average erection time, for a 180 m to 200 m tall elongate structure by an example system 2000 may be about 24 hours.

A lifting or elevation stroke of an example system 2000 may be about 3 m.

A lifting or elevation speed of an example system 2000 may be about 10 mm/s.

Thus, those skilled in the art of assembling, constructing and otherwise erecting large structures may appreciate the load bearing capabilities of example system described herein, in part afforded by the configurations of the jacking arrangements thereof as well as due to the configuration of the handling assemblies, interfacing elements thereof, and the unison of all of the apparatus, jacking arrangements, interfacing elements and handling assemblies together with the methods described herein, for iterative and sequential erection of structures.

Hence, other applications where any large, cumbersome, heavy and/or unwieldy sections of a structure of a substantial magnitude, i.e., sections of at least about 500 kgs to 1,000 kgs in mass and at least about 6 m³ to 9 m³ in volumetric size, and are to be handled, in particular moved, so as to facilitate erection, assembly and/or construction of at least part of said structures having millions of kilograms in total weight, and at least above 50 m to 100 m or 200 m in height.

As noted previously, known systems and methods for handling large, cumbersome, heavy and/or unwieldy sections of large structures of substantial magnitude, i.e., civil engineering structures or installations, such as external crane or self-climbing crane systems, may have associated structural limitations, significant labour and cost conditions and efficiency issues when those systems are used for erecting such large structures. Known systems employing a bottom-up lifting approach may require substantial support trussing, large and powerful actuators, lifting means and the like. Indeed, lifting the required tonnages associated with large structures may produce very large bending moments and forces that act on engaging elements as well as mounting/support points. Hence, trussing support structures may need to be employed for support and to counteract potentially significant bending moments.

These trussing support structures are inevitably large, unwieldy, heavy and cumbersome to assemble at a construction site, and therefore may create significant downtime and reductions in efficiency, despite the bottom-up lifting approach being initially employed to reduce downtime and inefficiency of previous crane systems. To reduce the number of sections to be handled for a tower of a given height, and therefore at least partly address the inefficiency, bottom-up lifting systems may be designed as large, 20-30 m structures for handling large 10-20 m tall sections of the tower being erected. These systems may face challenges when erecting towers of varying dimensions, i.e., having sections of different heights, diameters, or overall size, and especially for tapered towers where the entire system must be readjusted radially outwardly from an erection site as the sections increase in size.

The handling assembly of the present disclosure provides a plurality of spaced apart interfacing elements in the form of vertical elongate members, preferably short in height and hinged mutually about common float points. With this arrangement, the interfacing elements can couple to section in a manner that can resolve forces across the section. This configuration significantly reduces the form factor required to lift a section, since all contact points to the section (upper and lower engaging portions of each interfacing element) are hinged and therefore supported about a mutual float point, or pivot axis, as previously described. Forces, loads and bending moments created can therefore be substantially reduced, due to the short distances between said contact points to the section (upper and lower engaging portions of each interfacing element) to each other and to the mutual float point, and may even be substantially resolved across the section, or across the handling assembly, and more efficiently transferred to a surrounding jacking arrangement and thus to the foundation of the structure.

As such, the handling system and associated methods described herein can provide substantial improvements in lifting capacity when compared to the known bottom-up lifting system and methods. These improvements in turn reduce the need for hard-to-assemble, large and unwieldy trussing support structures. For example, a handling system having interfacing elements of 1.8 m in height (or between about 1 m to 3 m) and 0.55 m in width (or between about 0.5 m to about 1 m), the total height of the handling system may be only about 6.5 m, or between about 4 m to 8 m, depending on the application (i.e., height of sections to be handled and lifted). Given a handling system 6.5 m tall that is able handle equal if not larger lifting loads (as well as dynamic wind loads) as known 20-30 m tall bottom-up lifting systems, it will be appreciated that the present disclosure can provide substantial advantages in set-up time, modularity, transport costs and time, and the like.

Moreover, the smaller form-factor of said for example 6.5 m tall example system can enables faster iterative and sequential erection of a plurality of shorter sections (such as the example 2.4 m tall sections described above) of structure compared to the 10-20 m tall sections of known 20-30 m tall bottom-up lifting systems. This may justify a corresponding manufacturing process of match-casting (or otherwise forming) a larger number of smaller-height sections of an elongate structure, rather than a smaller number of larger-height sections of an elongate structure. Manufacturing smaller sections may enable substantial manufacturing cost and time/efficiency benefits, such as just-on-time casting or manufacturing, owing to reduced per-section or per-unit manufacturing requirements, both from an engineering and manufacturing cost point of view, when compared to per-section or per-unit manufacturing of larger sections.

Further still, the unwieldy trussing support structures, and large, powerful actuators of known bottom-up lifting systems may present difficulties in minor movement or precise adjustment of sections being handled or lifted. This results in limited ability to accurately align sections to one another, i.e., when lowering an elevated section onto a section below. Rather than attempting precise alignment, these systems may employ concrete grouting in between sections, or at least every 2^{nd} or 3^{rd} section, to effectively couple the bearing faces thereof and avoid at least some of the need for precise alignment. Time to cure, labour and cost associated with employing said grouting process creates even further downtime, inefficiency and costs.

By contrast, example systems and methods described herein can provide means for precise radial and vertical adjustment and control, as well as precise and efficient control of lower sections in a horizontal plane. When employed for erection of a wind turbine tower, the present disclosure may achieve cycle time of elevating, or adding to a notionally combined portion, of 3 sections per hour at a lifting or elevating speed of about 10 mm/s for an overall erection time of about 24 hours for a 180 m to 200 m tall tower.

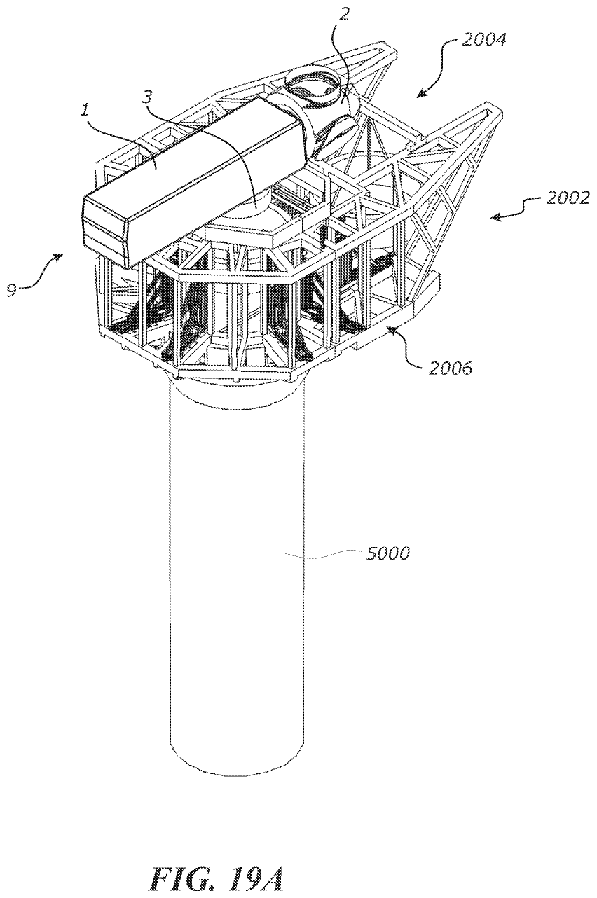

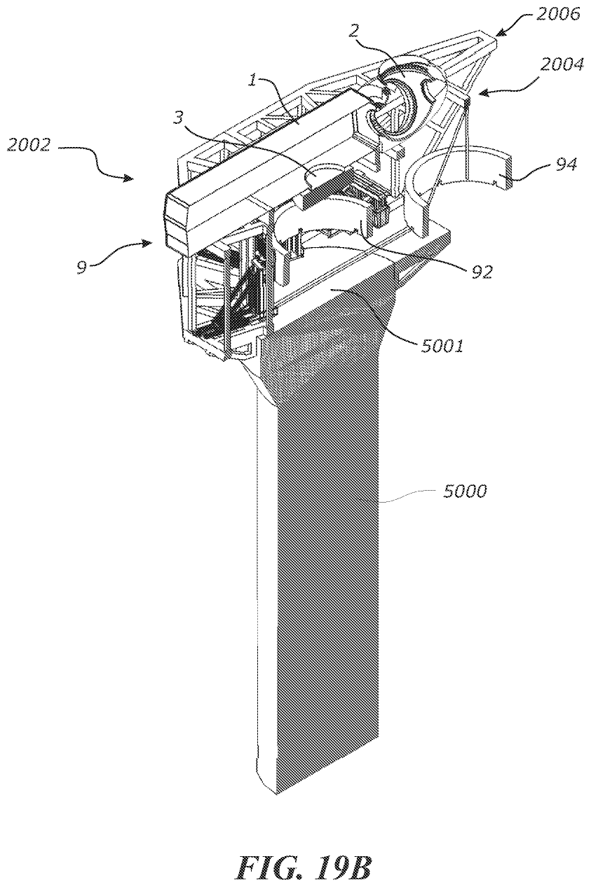

In addition to the advantages discussed above (and elsewhere in the specification), the handling system can also have the advantage of being set-up or employed where other systems may prove too cumbersome, heavy or complex. For instance, FIGS. 19A and 19B shows an example system 2002 employed for erection of a marine offshore wind turbine installation upon an installation pontoon 5000. Here, the system 2002 is surrounded, or encompassed, by a support truss frame 2006 which may generally have the same height as the system 2002 itself.

In the figures, an upper-most portion of the wind turbine installation (in this case, a notionally combined portion 9 having nacelle 1, rotor hub 2 and transition section 3) is already supported atop the top of said truss frame 2006. The system 2002, by way of the respective handling system and jacking arrangement, is coupled to and in the process of upwardly lifting a section 92 to the notionally combined portion 9, so as to connect to the lower-most section thereof (i.e., transition section 3).

As mentioned, the transport functionality of the displacement platform 3000 (provided by, for example, the roller assemblies 3120 and slots 4002), need not be employed in all examples. In this instance, a displacement platform, if employed, may simply reside atop the pontoon upper surface 5001 instead with a movable winch beam 2004 atop the truss frame 2006. This is shown to lift the next section 94 to be handled from a floating platform (barge, marine vessel, etc.) and then bring it closer to said system 2002 for handling.

The handling system of this example, together with jacking arrangement, the associated truss frame 2006 and winch beam 2004, as well as the already notionally combined portion 9 having nacelle 1, rotor hub 2 and transition section 3, may all be pre-arranged onshore, placed into/atop a marine vessel, and then lifted as a combined unit to atop the pontoon 5000.

Alternatively, individual interfacing elements and their corresponding jacking device may be separately and independently lifted and/or arranged about the pontoon 5000, followed by auxiliary hardware, truss frame 2006, etc.

This marine application of the handling system further demonstrates potential adaptability and modularity of the handling assembly, apparatus, displacement platform and method(s) described herein.

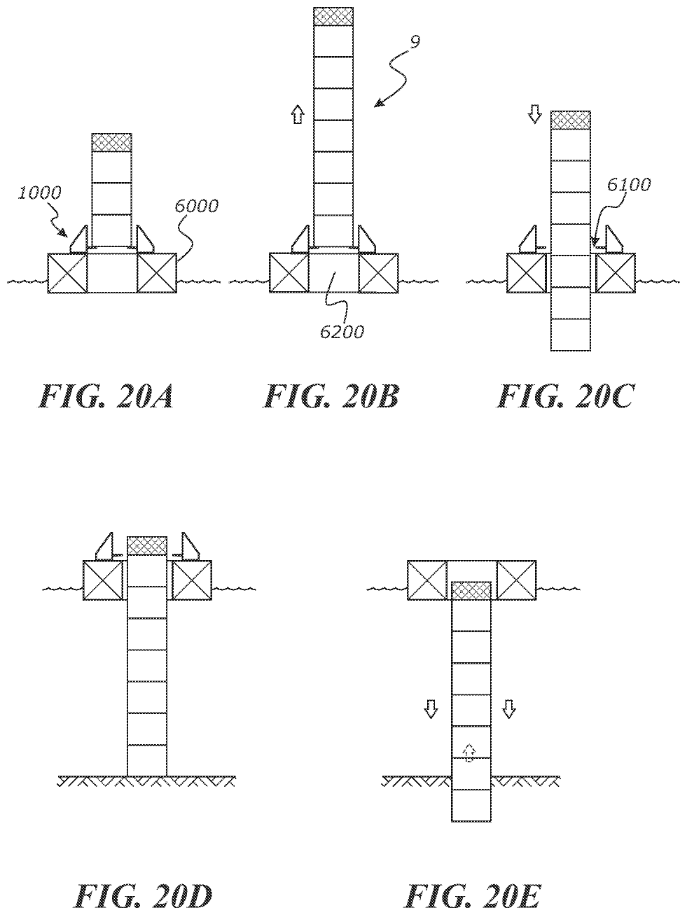

After assembling a structure or a portion of a structure by stacking sections, the handling system 1000 may be used to lower the structure or portion of the structure beneath the level of the handling system 1000. As shown in FIGS. 20A to 20E, for marine applications this can facilitate lowering a structure beneath the water level and embedding the lowermost section(s) into the sea bed, rather than constructing it atop a pre-existing pontoon 5000 or equivalent support structure. In other applications this can facilitate lowering a structure into a pit or onto a foundation beneath the level of the handling assembly 1000.

Initial stacking of the sections may be carried out in accordance with the example method(s) described in FIGS. 12A to 12H and/or FIGS. 16A to 16F and/or FIGS. 17A-17F, thereby creating the notionally combined portion 9 of the structure which is to be lowered. After the notionally combined portion 9 is assembled to a suitable height but before it is lowered (i.e., while in the position shown in FIG. 20B), it is post-tensioned or the sections secured together in some other way. This allows the notionally combined portion 9 to retain its structural integrity while being lowered (as shown in FIGS. 20C-20E), as sections of the notionally combined portion 9 beneath the level of the handling assembly will be hanging from the remainder of the combined portion 9 and unsupported from beneath until the lowering operation is completed.

Preferably the handling system 1000 both assembles and lowers the notionally combined portion 9 at the same location. To facilitate this, a support apparatus 6100 within the erection footprint of the handling system 1000 can assume a supporting condition in which the weight of the structure is supported by the support apparatus, but can be reconfigured to a free passage condition in which the structure can be lowered down through the locus of the handling system 1000 without obstruction. The support apparatus 6100 could take any suitable form, for example hydraulically driven pins that extend across an aperture 6200 from the side, horizontally movable surfaces that provide for a contractable and expandable aperture 6200, or some other arrangement.

In the case of lowering beneath the water level, the handling system 1000 is preferably provided atop a barge 6000 comprising an aperture 6200 associated with the support apparatus 6100. Preferably the aperture is located centrally on the barge 6000.

With the support apparatus 6100 in the supporting condition to support the lowermost section, the handling system 1000 can operate as normal to erect the notionally combined portion 9. Once the notionally combined portion 9 is of suitable height and post-tensioning is complete, the handling system 1000 can re-engage to support the structure and allow the support apparatus 6100 to reconfigure into the free passage condition.

Lowering of the notionally combined portion 9 preferably occurs in stages akin to the reverse of what occurs during stacking. That is, the interfacing elements 100 of the handling system 1000 repeatedly move up and down to engage, lower, and then disengage a series of sections consecutively. However, in the case of a lowering operation, when the handling system 1000 moves to engage a higher section the structure must be adequately supported lest the structure fall through the aperture 6200.

In one embodiment, the support apparatus 6100 moves back and forth between the supporting and free passage conditions to facilitate lowering in stages. Thus, the support apparatus 6100 is in the free passage condition when the handling system 1000 is engaged with a section and lowering it, but moves to the supporting condition while the handling system 1000 disengages and raises up to engage a new section.

In another embodiment, subsets of the interfacing elements 100 of the handling system 1000 may move in an alternating fashion to facilitate lowering in stages. That is, half (or approximately half) of the interfacing elements 100 may be lowered while they engage section holes 92H to support the structure, while the remaining interfacing elements 100 may be disengaged and raised until they reach the above set of section holes 92H and engage them. The roles of the two subsets of interfacing elements 100 then swap to repeat the lowering process iteratively.

For this alternating fashion of lowering, the structure must be supportable by only one subset (typically half) of the interfacing elements 100. Therefore, maximum load capacity may be reduced compared to stacking. However, a lowering operation does not require work to be performed against the weight of the structure which may mitigate load capacity issues to some extent or at least increase the speed at which the lowering operation can occur compared to a lifting operation over the same height.

The lowering operation is complete when the lowermost section has settled in a final position below the level of the handling system 1000 (i.e., below the non-elevated position previously described in relation to FIG. 12C).

A suitable height for the notionally combined portion 9 (prior to lowering) will depend on the application. For lowering to a seabed, it may be desirable for the top of the structure to be roughly at the water level subsequent to the lowermost section settling in the seabed (as shown in FIG. 20E). This may allow the barge 6000 to be more easily removed. For lowering into a pit or similar, the depth of the pit must be accounted for.

After lowering into a seabed, the notionally combined portion 9 may act as an offshore foundation for a taller structure that is supported in the seabed. The taller structure could optionally be constructed through a further iteration of the original method.

Those skilled in the art will therefore appreciate how a handling system as described herein can be employed not only for handling sections for erection of an elongate structure, such as a tower, but many other applications where handling of large sections of a structure may benefit from significant form-factor reductions as described.

Any given application benefiting from a modular, easy to assemble lifting or handling system, for large heavy sections of a structure, could be provided at least significant efficiency, cost, and transport/assembly improvements, thanks to the resulting reduction in form-factor, as well as the lifting and load capacity still enabled by the handling system implemented as desired.

It may be desirable in some circumstances for sections of a structure (e.g., tower sections for a wind turbine installation) to be transported to or around an installation site, such as for delivering the sections to the alignment platform 3000 described previously.

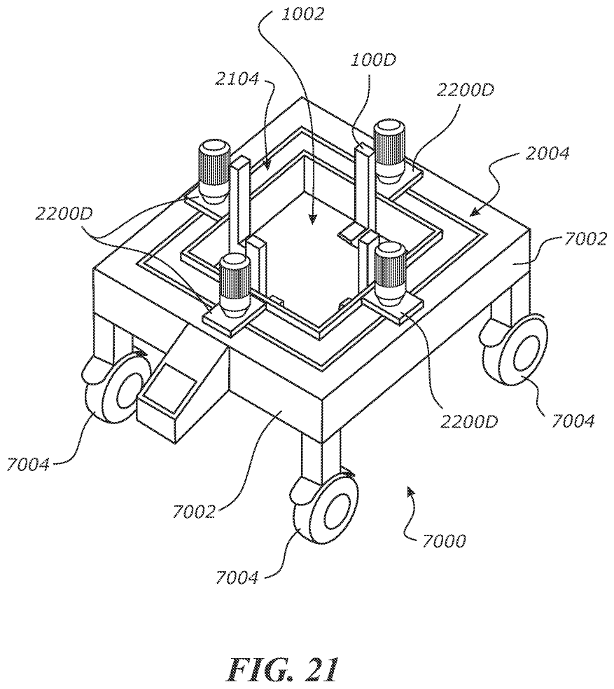

FIG. 21 shows an example logistics or handling operations vehicle 7000, having a body 7002 and an example system comprising the handling assembly 1002 of FIG. 1B, and associated jacking arrangement 2104 (with example jacking devices 2200D) carried by said body 7002, and vehicle movement means, such as steerable actuated wheels 7004 for moving said vehicle around a storage or manufacturing facility, for example. The vehicle 7000 may be used to lift, handle and move sections for storage and/or to appropriate trucks, trains, containers etc, as desired, for final transport to an erection site of said structure.

In one example, 2, 3, 4, 6 or more interfacing elements are arranged spaced apart on a notional locus (circular, orthogonal, polygonal, etc.), within the frame or body of a movable platform or vehicle, for handling large sections of a structure. Shipping or logistic operations, or transport of sections of structure on or off-site, for example, may benefit from a vehicle having a handling assembly as described, where said vehicle can handle significant lifting and load requirements while still being relatively volumetrically small compared to whatever crane, vehicle or other systems was previously employed.

Further, some applications may benefit from a plurality of independently movable jacking devices, i.e., two or more interfacing elements mounted on separate movable platforms, that can position around a section to be handled at a variable spacing thereabout, or at variable positions around the section. A system of independently movable jacking devices may be used for delivering sections of a structure (e.g., sections of a wind tower) on site and onto, for example, the alignment platform previously described.

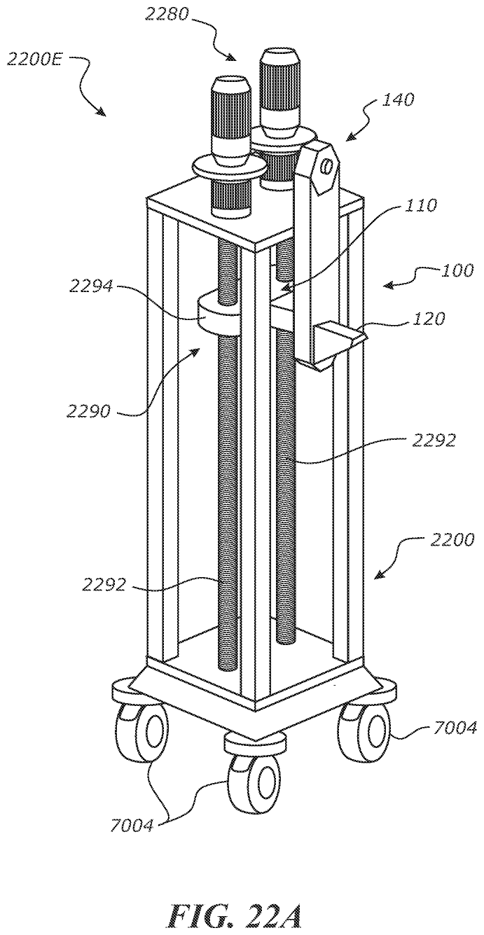

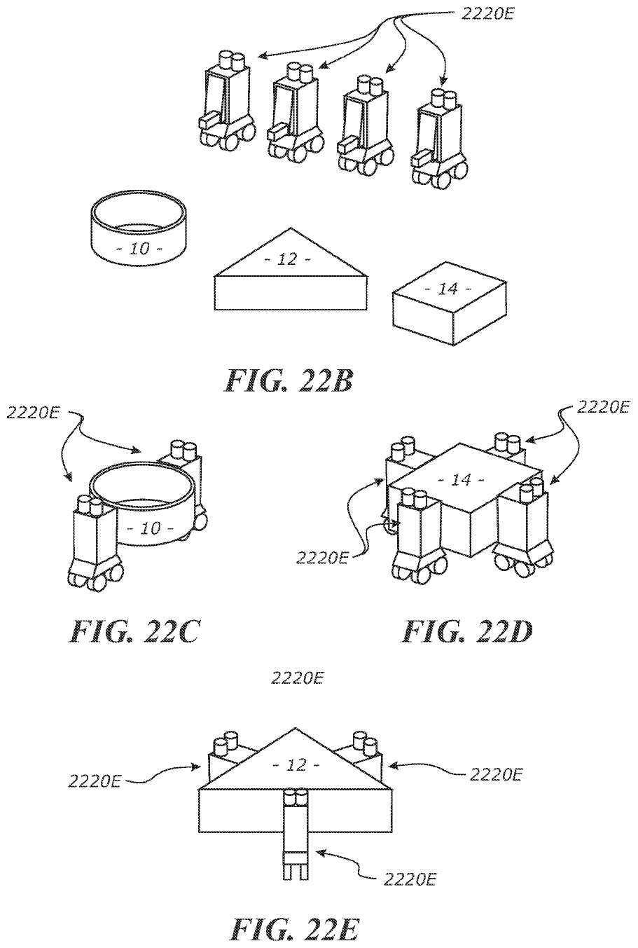

FIG. 22A shows an example mobile jacking device 2200E comprising an interfacing element 100 for handling a section of a structure. The mobile platform interfacing element 100 may be configured in the same manner as the example interfacing elements previously described, where like parts are indicated by common reference numerals. The mobile interfacing element 100 is shown comprising a lower engaging portion 120 and upper engaging portion 140, and a float point 110 about which the engaging portions 120, 140 both freely pivot.

The mobile jacking device 2200E may be configured for use with at least one other mobile jacking device as part of a mobile handling system, in which a plurality of mobile interfacing elements 100 are each independently moveable towards and/or away from a section to be handled (to enable a coupling thereto and/or release therefrom), and capable of being independently positioned in a spaced-apart manner around the section.

The same features and functionality of example handling systems already described may apply to the present mobile handling system. In particular, the interfacing elements 100 may be of the freely-pivoting type configured for engagement of both upper and lower engaging portions to grip a section and substantially resolves forces across the section, as described previously. However, other interfacing elements can be used (such as the non-clamping interfacing elements).

The mobile jacking device 2200E is shown configured in much the same manner as the example jacking device 2200 of the example system 2000 described previously, wherein the jacking device 2200E comprises a support frame 2200 supporting at least part of the interfacing element 100, an elevation mechanism 2290 comprising at least one upright elongate threaded rod 2292 and a prime carriage 2294 coupled thereto (both housed at least partially within and by the support frame 2200). The prime carriage 2294 may be configured to support a lower curved surface 112 of the float point 110 of the interfacing element 100. An elevation drive unit 2280 may be provided to actuate rotation of the at least one upright elongate threaded rod 2292 of the elevation mechanism 2290, such that the prime carriage 2294 coupled thereto moves upwards or downwards along said threaded rod 2292 to action vertical movement of the interfacing element 100.

The example mobile jacking device 2200E may hence be used as part of handling system for lifting or lowering of sections of a structure.

The example mobile jacking device 2200E is also shown comprising movement means to move the support frame 2200 and hence the mobile interfacing element 100 horizontally along a ground surface, such as that of a storage, transport or manufacturing site (for sections of the structure, or at or around the erection site of the structure itself). The movement means can provide independent positioning of the interfacing element 100 around a section to be handled and movability towards and/or away from the section (analogously to the slider mechanism of, e.g., FIG. 8).

The movement means may comprise for example at least one steerable, powered or actuated wheel. Here, four steerable powered wheels 7004 are shown, similarly to the handling operations vehicle 7000. Those skilled in the art may envisage other suitable movement means.

Each mobile jacking device may be controlled centrally (e.g., via a central controller), such that the mobile devices move and function cooperatively (e.g., in concert with one another). For example, the movement means and/or elevation mechanisms of each mobile jacking device may be controlled centrally. In some examples, at least some of the movement of the mobile jacking devices may be autonomous. In other examples, the mobile jacking devices may be controlled manually.

The movement means 7004 permit each mobile jacking device 2200E of a plurality to position around a section to be handled in a circular, orthogonal and/or polygonal formation, at any desired spacing, around any given size or shaped section. The movement means 7004 may allow for translation radially inwardly and outwardly relative a vertical axis of the section, and substantially about multiple horizontal axis, i.e., through a horizontal plane, to achieve equivalent function of the translation mechanism described in the previous examples.

The positioning of mobile jacking devices is illustrated in FIGS. 19B to 19E, where in FIG. 19B a plurality of mobile jacking devices 2200E is shown near a circular section 10, a triangular or polygonal section 12 and an orthogonal or square section 14. FIG. 19C demonstrates two of said mobile jacking devices 2200E moved to engage with and handle the circular section 10;

FIG. 19D demonstrates three of said mobile jacking devices 2200E moved to couple with and handle the polygonal section 12, i.e., one at each of its three sides; and FIG. 19E demonstrates four of said mobile jacking devices 2200E moved to couple with and handle the square section 14, i.e., one at each of its four sides. Many other configurations may be envisaged.

Hence, it will be appreciated that additional modularity and utility may be provided by provision of a plurality of mobile jacking devices at a worksite for movement of sections having varying sizes and shapes. The independent movement of jacking devices can allow differences in section size shape and transport/movement destination to be more easily accounted for and adapted to. The mobile handling system may be used in combination with the example handling system 2000 (or any other handling system as described herein) as part of a larger system.

Those skilled in the art will appreciate that any dimensions provided as examples could vary, i.e., be significantly reduced or enlarged, to suit certain applications, for handling certain structures of a particular size. This, together with the any given number of a plurality of interfacing elements, arranged about any desired shape, in any spaced-apart manner, provides a wide range of potential implementations and applications for the handling system.

Use of numbering or ordering terms such as “first”, “second”, “third”, etc., herein in relation to sections of a structure, or a section of a plurality of sections, or a series or group of sections “notionally numbered sequentially”, will be appreciated to be notional, illustrative and for the purposes of explanation only. Other section(s) may be present prior to, or after, said “first”, “second”, “third”, etc., section(s).

Moreover, vertical positional terms such as “upper”, “lower”, “upper-most”, “lower-most”, etc., are also provided for explanatory purposes only with reference to a generally vertical or upright frame of reference.

Where reference has been made to elements or integers having known equivalents, then such equivalents are included as if they were individually set forth.

Although the disclosure has been described by way of example and with reference to particular embodiments, it is to be understood that modifications and/or improvements may be made without departing from the scope or spirit of the disclosure.

In addition, where features or aspects of the disclosure are described in terms of Markush groups, those skilled in the art will recognise that the disclosure is also thereby described in terms of any individual member or subgroup of members of the Markush group.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A handling system for assembling an elongate structure from a plurality of sections along a vertical axis, the handling system comprising:
a) a plurality of spaced apart interfacing elements for engaging a section of the structure to be handled,
b) a jacking arrangement comprising at least one a plurality of jacking devices configured to move the interfacing elements vertically for lifting one or more sections of the structure, wherein each of the plurality of jacking devices comprises:
i. a support frame, such that the jacking devices are arranged to transfer load to a foundation via the support frames during lifting of one or more sections of the structure, and
ii. a translation mechanism configured to move a respective support frame radially relative to the vertical axis, such that the jacking devices are configured to move the interfacing elements radially relative to the vertical axis for engaging and/or disengaging a section to be handled.

2. The handling system of claim 1, wherein the jacking arrangement comprises a plurality of jacking devices, each configured to move a respective interfacing element of the plurality of interfacing elements.

3. The handling system of claim 1, wherein the jacking arrangement comprises a bridged arrangement comprising a pair of jacking devices and an intermediate beam spanning therebetween for moving one or more (preferably two) interfacing elements of the plurality of interfacing elements in unison, wherein said one or more interfacing elements are supported on said intermediate beam and wherein the bridged arrangement is configured to provide a clearance zone through which a section of the structure can pass for handling by the jacking arrangement.

4. The handling system of claim 3, wherein the intermediate beam comprises two interfacing elements configured to translate horizontally along said beam to vary a horizontal spacing from one another.

5. The handling system of claim 3, wherein the bridged arrangement and the plurality of jacking devices are configured to move the interfacing elements radially relative the vertical axis in unison.

6. The handling system of claim 1, wherein the interfacing elements are distributed (preferably evenly and/or symmetrically) around a section to be handled and/or around a notional handling system locus (preferably a circle or section thereof).

7. (canceled)

8. The handling system of claim 1, wherein each of the plurality of jacking devices comprises an elevation mechanism for moving the interfacing elements vertically.

9. The handling system of claim 8, wherein the elevation mechanism is at least partially housed within a support frame of the jacking device.

10. The handling system of claim 8, wherein the elevation mechanism is a screw-type mechanism, such as a roller screw.

11. The handling system of claim 10, wherein the elevation mechanism comprises at least one (preferably two) upright threaded rod and a carriage configured to move along the at least one upright threaded rod, wherein the carriage is connected to a respective interfacing element to cause vertical movement of said interfacing element.

12. The handling system of claim 11, wherein the elevation mechanism comprises an elevation drive unit configured to rotate the at least one upright threaded rod of the elevation mechanism, such that the carriage moves upwards or downwards along said threaded rod to cause vertical movement of the respective interfacing element.

13. (canceled)

14. The handling system of claim 1, wherein the translation mechanism is further configured to adjust the radial position of the interfacing elements to engage sections of various diameters.

15. The handling system of claim 13, wherein the translation mechanism is or comprises a horizontal slider mechanism.

16. The handling system of claim 15, wherein the horizontal slider mechanism comprises a slider frame along which the support frame of the jacking device can move.

17. The handling system of claim 16, wherein the slider frame is secured (e.g., bolted) to the foundation.

18. The handling system of claim 16, wherein the slider frame comprises a shaft extending longitudinally through a housing and a drive unit configured to actuate the shaft for translation of the support frame along the slider frame.

19. The handling system of claim 1, further comprising a controller configured for synchronous and/or independent control of the jacking devices.

20. The handling system of claim 19, wherein the controller is configured to adjust the elevation of the interfacing elements in response to load and/or alignment data.

21. The handling system of claim 1, further comprising an alignment platform for supporting a lower section of the tower beneath one or more upper sections of the tower being handled by the jacking arrangement, wherein the alignment platform is moveable in a horizontal plane to enable alignment of the lower section with the one or more upper sections.

22. The handling system of claim 21, wherein the alignment platform has at least two degrees of freedom including translational and/or rotational degrees of freedom.

23. The handling system of claim 21, wherein the alignment platform is moveable freely in the horizontal plane and/or reactively under the influence of an external force such that the alignment platform moves in response to engaging of alignment features of adjacent sections.

24. The handling system of claim 21, wherein the alignment platform comprises at least one displacement prop arranged for said movement in the horizontal plane.

25. The handling system of claim 24, wherein the at least one displacement prop comprises an upper and lower end, and wherein the upper and/or lower end comprises a spherical ball-joint interface.

26. The handling system of claim 24, wherein the alignment platform comprises a pair of elongate support arms each coupled to one or more carriages via one or more displacement props.

27. The handling system of claim 26, wherein the carriages are arranged to travel along rails or tracks for transporting sections of the structure to the jacking arrangement.

28. The handling system of claim 21, wherein the alignment platform has an elevation mechanism (such as one or more hydraulic cylinders) for lifting the lower section of the structure into contact with the one or more upper sections.

29. The handling system of claim 1, wherein the elongate structure comprises an elongate tower of a wind turbine installation and optionally wherein the sections of the elongate tower are concrete rings.

30. A mobile jacking device for handling a section of a structure, the mobile jacking device comprising:
an interfacing element for engaging a section to be handled, the interfacing element comprising:
a) a lower engaging portion and upper engaging portion, and
b) a float point about which the engaging portions both freely pivot such that contact and engagement of either of the upper or lower engaging portion with said section causes the other of the upper or lower engaging portion to contact and engage said section,
wherein the interfacing element is moveable vertically for lifting said section to be handled, and
wherein the mobile jacking device is arranged for travelling along the ground.

31. A handling system comprising a plurality of mobile jacking devices as defined in claim 30, wherein the plurality of mobile jacking devices is configured to cooperate to handle a section of a tower.

32. The handling system of claim 31, wherein the plurality of mobile jacking devices is arranged for synchronous and/or independent operation.

33. A method of assembling an elongate structure from a plurality of sections thereof along a vertical axis using the handling system of claim 1, the method comprising:
a) arranging the handling system at an erection site,
b) positioning a first section of the plurality of sections to substantially align with the vertical axis,
c) moving the interfacing elements towards the first section to engage said first section by moving the support frames of the jacking devices via the translation mechanisms,
d) using the jacking arrangement to lift the first section along said vertical axis to an elevated position,
e) positioning a second section of the plurality of sections underneath the elevated first section to substantially align with the vertical axis,
f) bringing the first section and second section into contact by lowering the first section towards the second section and/or raising the second section towards the first section, to form a combined portion of the structure, wherein the second section defines a lower section of said combined portion,
g) moving the interfacing elements away from the first section to release therefrom, by moving the support frames of the jacking devices via the translation mechanisms, and repositioning the interfacing elements to engage the lower section of the combined portion,
h) using the jacking arrangement to lift the lower section along said vertical axis to an elevated position thereby elevating the combined portion,
i) repeating steps e) to h) for consecutively numbered sections so as to add sections in sequence to an iteratively elongating combined portion, thereby assembling the elongate structure from the bottom up.

34. The method of claim 33, wherein step a) of arranging the handling system comprises securing the jacking devices to a foundation.

35. The method of claim 33, wherein the step of positioning the second section underneath the elevated first section of step e) comprises providing the second section on the alignment platform.

36. The method of claim 35, wherein step f) comprises lowering the first section using the jacking arrangement, and/or raising the second section using the alignment platform, such that alignment features at a lower end of the first section engage alignment features at an upper end of the second section, wherein said engagement informs horizontal displacement of the second section by virtue of the alignment platform moving freely in the horizontal plane.

37. The method of claim 36, wherein during step f) the interfacing elements of the jacking arrangement remain substantially engaged to said first section to support a load of said first section.

38. The method of claim 36, wherein during step f), once both sections are in substantially complete alignment, the alignment platform is lowered into a recess of a foundation, in unison with the vertical lowering of the jacking arrangement to lower said first section, so that the entire weight of said notionally combined portion is imparted onto said foundation.

39. The method of claim 35, wherein step b) of positioning the first section, and/or step e) of positioning the second section, comprises placing the respective section on the alignment platform and transporting the alignment platform horizontally to said position underneath the respective elevated section.

40. The method of claim 39, wherein step b) and/or step e) e) further comprise elevating the bridged arrangement of the jacking arrangement to provide the clearance zone and transporting the alignment platform with the respective section therethrough.

41. The method of claim 39, further comprising transporting the first section and/or second section to the alignment platform using the mobile handling system.

42. The method of claim 33, wherein the elongate structure comprises an elongate tower of a wind turbine installation.

43. The method of claim 33, further comprising steps of:
j. post-tensioning or otherwise securing together the sections of the combined portion of the structure once it has reached a suitable height; and
k. lowering the combined portion of the structure along the vertical axis until the lower most section comes to rest in a final position below the non-elevated position.

44. The method of claim 43, wherein step k. comprises:
k1) engaging, via the interfacing elements, the section of the combined portion of the structure that is currently in the first elevation position;
k2) lowering the notionally combined portion of the structure until the engaged section is in the non-elevated position, and then disengaging the engaged section;
k3) repeating steps k1. and k2. for consecutive sections of the combined portion of the structure until the lower most section comes to rest in the final position below the non-elevated position.

45. The method of claim 43, wherein step k. involves lowering the combined portion of the structure at least partially beneath a water line such that the final position of the lower most section is in a seabed.

46. The method of claim 43, wherein step k. involves lowering the combined portion of the structure at least partially into a pit such that the final position of the lower most section is in the pit.

47. The handling system of claim 2, wherein the jacking arrangement comprises an arrangement of structurally and spatially separate jacking devices capable of moving independently and synchronously.
